(19) United States
(12) Patent Application Publication
(10) Pub. No.: US 2026/0300018 A1
(43) Pub. Date: Oct. 1, 2026

(54) IN-VEHICLE DEVICE, SERVER DEVICE, RESOURCE CONTROL METHOD, RESOURCE CONTROL SUPPORT METHOD, AND STORAGE MEDIUM

(71) Applicants: SUMITOMO ELECTRIC INDUSTRIES, LTD., Osaka-shi, Osaka (JP); AUTONETWORKS TECHNOLOGIES, LTD., Yokkaichi-shi, Mie (JP); SUMITOMO WIRING SYSTEMS, LTD., Yokkaichi-shi, Mie (JP)

(72) Inventor: Akihiro OGAWA, Osaka-shi (JP)

(73) Assignees: SUMITOMO ELECTRIC INDUSTRIES, LTD., Osaka-shi, Osaka (JP); AUTONETWORKS TECHNOLOGIES, LTD., Yokkaichi-shi, Mie (JP); SUMITOMO WIRING SYSTEMS, LTD., Yokkaichi-shi, Mie (JP)

(21) Appl. No.: 18/992,833

(22) PCT Filed: May 26, 2023
(86) PCT No.: PCT/JP2023/019598

§ 371 Date: Jan. 9, 2025

(30) Foreign Application Priority Data
Jul. 21, 2022 (JP) 2022-116047

(51) Int. Cl. G06F 9/50

(52) U.S. Cl. CPC G06F 9/5038; G06F 2209/5019; G06F 2209/506; G06F 2209/508

(57) ABSTRACT

An in-vehicle device to be installed in a vehicle, the in-vehicle device including: a communication outlet that is configured to communicate with an external device; and a processor that is configured to: acquire, via the communication outlet, actual information of resource consumption by an other vehicle other than the vehicle relating to when the other vehicle travelled through a scheduled travel area of the vehicle; estimate resource consumption that varies temporally with travel of the vehicle, when the vehicle travels through the scheduled travel area, based on the actual information acquired; and control resource consumption, by allocating an execution period of predetermined application software to a predetermined period, according to the resource consumption estimated.

### BACKGROUND

The present disclosure relates to an in-vehicle device, a server device, a resource control method, a resource control support method, and a storage medium. This disclosure claims priority to Japanese Patent Application No. 2022-116047 filed on Jul. 21, 2022, the entire contents of which are hereby incorporated by reference.

In next-generation connected services that enable high-speed, high-capacity communication, there is an increase in the data volume of communication between vehicles and out-of-vehicle devices. This has also resulted in an increase in the range of temporal variation in resource consumption (consumption of communication resources, computing resources, etc.) by in-vehicle devices installed in vehicles.

In such situations, services that cannot meet allowable delay times can occur during high load periods when the communication data volume peaks. If high-performance processors capable of handling high loads are installed in in-vehicle devices, it may be possible to suppress the occurrence of services that cannot meet allowable delay times, even during high load periods. However, in that case, the cost of in-vehicle devices increases due to overspecification.

As a technology for suppressing a decrease in system responsiveness during high load periods, JP 2019-109744A described below proposes a technology relating to an automotive electronic control unit that distributes the load by dynamically allocating processor cores that process tasks. The automotive electronic control unit of JP 2019-109744A is equipped with a multi-core processor in which a plurality of processor cores are integrated. When a task related to interrupt processing in response to a change in the driving state occurs, this automotive electronic control unit executes first distribution processing for distributing the load according to the load situation of the plurality of processor cores with regard to the task. The automotive electronic control unit, furthermore, executes second distribution processing for predicting changes in the driving state and distributing the load according to the load situation of the plurality of processor cores with regard to tasks that are affected by the prediction result, when the engine speed is less than or equal to a predetermined value.

### SUMMARY

An in-vehicle device according to an aspect of the present disclosure is an in-vehicle device to be installed in a vehicle, the in-vehicle device including: a communication outlet that is configured to communicate with an external device; and a processor that is configured to acquire, via the communication outlet, actual information of resource consumption by an other vehicle other than the vehicle relating to when the other vehicle travelled through a scheduled travel area of the vehicle; estimate resource consumption that varies temporally with travel of the vehicle, when the vehicle travels through the scheduled travel area, based on the actual information acquired; and control resource consumption, by allocating an execution period of predetermined application software to a predetermined period, according to the resource consumption estimated.

The present disclosure can be realized not only as an in-vehicle device, a server device, a resource control method, a resource control support method, and a computer program that include such characteristic configuration, but also as a storage medium on which is recorded a program for causing a computer to execute characteristic steps that are executed by the in-vehicle device or the server device. Furthermore, the present disclosure can also be realized as another system or device that includes the in-vehicle device or the server device.

### BRIEF DESCRIPTION OF THE DRAWINGS

FIG. 1 is a diagram for describing the overall configuration of a system according to a first embodiment.

FIG. 2 is a diagram for describing a vehicle equipped with an in-vehicle device shown in FIG. 1.

FIG. 3 is a diagram for describing a dynamic map.

FIG. 4 is a diagram for describing resource control that is executed in the in-vehicle device shown in FIG. 1.

FIG. 5 is a diagram for describing resource control that is executed in the in-vehicle device shown in FIG. 1.

FIG. 6 is a diagram for describing a method of creating an actual resource consumption map in a server device shown in FIG. 1.

FIG. 7 is a diagram showing an example of the contents of an actual resource consumption map.

FIG. 8 is a block diagram showing an example of the functional configuration of the in-vehicle device shown in FIG. 1.

FIG. 9 is a block diagram showing an example of the hardware configuration of an in-vehicle device (GW (Gateway) device) shown in FIG. 8.

FIG. 10 is a block diagram showing an example of the hardware configuration of the server device shown in FIG. 1.

FIG. 11 is a block diagram showing an example of the functional configuration of the server device shown in FIG. 10.

FIG. 12 is a flowchart showing an example of the control structure of a program that is executed in the in-vehicle device according to the first embodiment.

FIG. 13 is a flowchart showing an example of the control structure of a program that is executed in the server device according to the first embodiment.

FIG. 14 is a flowchart showing an example of the control structure of a program that is executed in a server device according to a first variation.

FIG. 15 is a flowchart showing an example of the control structure of a program that is executed in an in-vehicle device according to a second variation.

FIG. 16 is a flowchart showing an example of the control structure of a program that is executed in a server device according to the second variation.

FIG. 17 is a flowchart showing an example of the control structure of a program that is executed in an in-vehicle device according to a third variation.

FIG. 18 is a flowchart showing an example of the control structure of a program that is executed in a server device according to the third variation.

FIG. 19 is a flowchart showing an example of the control structure of a program that is executed in a server device according to a fourth variation.

FIG. 20 is a flowchart showing an example of the control structure of a program that is executed in an in-vehicle device according to the fourth variation.

FIG. 21 is a diagram for describing the configuration of an in-vehicle device according to a second embodiment.

FIG. 22 is a block diagram showing an example of the functional configuration of the in-vehicle device (GW device) shown in FIG. 21.

FIG. 23 is a flowchart showing an example of the control structure of a program that is executed in the in-vehicle device according to the second embodiment.

FIG. 24 is a block diagram showing an example of the functional configuration of a server device according to a third embodiment.

FIG. 25 is a block diagram showing an example of the functional configuration of an in-vehicle device (GW device) according to the third embodiment.

FIG. 26 is a flowchart showing an example of the control structure of a program that is executed in the server device according to the third embodiment.

FIG. 27 is a flowchart showing an example of the control structure of a program that is executed in the in-vehicle device according to the third embodiment.

### DETAILED DESCRIPTION OF EMBODIMENTS

### Technical Problem

With the technology of the disclosure in JP 2019-109744A, tasks are dynamically allocated to a plurality of processor cores by predicting changes in the driving state. A high load state caused by interrupt processing in response to changes in the driving state can thereby be eliminated. However, it is difficult to predict load increases caused by out-of-vehicle wireless communication from changes in the driving state. Thus, with the technology of the disclosure in JP 2019-109744A, there is a chance that the responsiveness of services will decrease during high load periods caused by out-of-vehicle wireless communication.

An exemplary aspect of the disclosure is to provide an in-vehicle device, a server device, a resource control method, a resource control support method, and a computer program that are capable of suppressing a decrease in responsiveness even during high load periods caused by out-of-vehicle wireless communication.

### Advantageous Effects of Disclosure

According to the present disclosure, an in-vehicle device, a server device, a resource control method, a resource control support method, and a computer program that are capable of suppressing a decrease in responsiveness even during high load periods caused by out-of-vehicle wireless communication can be provided.

### Description of Embodiments of Disclosure

Preferred embodiments of the disclosure will now be enumerated and described. At least some of the embodiments described below may be combined in any desired manner.

(1) An in-vehicle device according to a first aspect of the present disclosure is an in-vehicle device to be installed in a vehicle, including a communication unit configured to communicate with an external device, an information acquisition unit configured to acquire, via the communication unit, actual information of resource consumption by another vehicle other than the vehicle relating to when the other vehicle travelled through a scheduled travel area of the vehicle, an estimation unit configured to estimate resource consumption that varies temporally with travel of the vehicle, in a case of the vehicle travelling through the scheduled travel area, based on the actual information acquired by the information acquisition unit, and a resource control unit configured to control resource consumption, by allocating an execution period of predetermined application software to a predetermined period, according to an estimation result of the estimation unit.

The information acquisition unit acquires actual information of resource consumption by another vehicle other than the vehicle in which the in-vehicle device is installed relating to when the other vehicle travelled through the scheduled travel area of the vehicle. Based on the acquired actual information, the estimation unit estimates resource consumption that varies temporally with travel of the vehicle. That is, load increases caused by out-of-vehicle wireless communication in the case of the vehicle travelling through the scheduled travel area are predicted, based on this actual information. The resource control unit controls resource consumption, by allocating an execution period of predetermined application software to periods outside of high load periods, for example. The in-vehicle device is thereby able to suppress a decrease in responsiveness even during high load periods caused by out-of-vehicle wireless communication. Additionally, the occurrence of services that cannot meet the allowable delay time can be suppressed, without installing a high-performance processor in the in-vehicle device. As a result, a decrease in responsiveness can be suppressed while suppressing an increase in the cost of the in-vehicle device.

(2) In (1) above, a configuration may be adopted in which the estimation unit estimates, for each travel section of the scheduled travel area, resource consumption that varies according to the travel section and includes resource consumption due to execution of application software that requires real-time execution of processing, and the resource control unit controls resource consumption, by allocating an execution period of application software that does not require real-time execution of processing to the predetermined period, according to an estimation result of the estimation unit. By adopting such a configuration, the execution period of application software that does not require real-time performance can be allocated to periods in which resources are available. That is, execution of application software that does not require real-time performance can be prevented during periods in which resource consumption increases due to the execution of application software that requires real-time performance. The execution periods of application software can thereby be distributed, and thus a decrease in responsiveness can be easily suppressed during high load periods caused by out-of-vehicle wireless communication. Note that whether or not application software requires real-time performance can be determined based on whether an allowable delay time for communication is less than or equal to a predetermined threshold, for example.

(3) In (1) or (2) above, a configuration may be adopted in which the external device includes a server device configured to collect the actual information of resource consumption from a plurality of other vehicles, and create an actual resource consumption map in which actual resource consumption is set in each travel section of the scheduled travel area, based on the collected actual information, the information acquisition unit acquires the actual resource consumption map as the actual information from the server device, via the communication unit, and the estimation unit estimates the resource consumption for each travel section of the scheduled travel area, based on the actual resource consumption map. By adopting such a configuration, resource consumption that varies temporally with travel of the vehicle can be easily estimated. That is, load increases caused by out-of-vehicle wireless communication in the case of the vehicle travelling through the scheduled travel area can be easily predicted.

(4) In (1) or (2) above, a configuration may be adopted in which the external device includes an in-vehicle device installed in another vehicle other than the vehicle, the information acquisition unit acquires, via the communication unit, actual information of resource consumption in the scheduled travel area from the in-vehicle device of the other vehicle that has travelled through the scheduled travel area of the vehicle, and the estimation unit estimates the resource consumption for each travel section of the scheduled travel area, based on the actual information of resource consumption acquired from the in-vehicle device of the other vehicle. Resource consumption that varies temporally with travel of the vehicle can also be easily estimated with this configuration. Thus, a decrease in responsiveness during high load periods caused by out-of-vehicle wireless communication can be easily suppressed.

(5) In any of (1) to (4) above, a configuration may be adopted in which the resource control unit allocates an execution period of application software that does not require real-time execution of processing to a scheduled travel period of a travel section in which a ratio of resource consumption estimated by the estimation unit to a resource usage limit is less than or equal to a predetermined value. The execution period of application software that does not require real-time performance can thereby be easily set to periods other than high load periods.

(6) In (5) above, a configuration may be adopted in which the predetermined value is set based on resource consumption of the application software that does not require real-time performance. The execution period of application software that does not require real-time performance can thereby be set to periods in which resources for executing the application software that does not require real-time performance are secured.

(7) In any of (1) to (6) above, a configuration may be adopted in which the actual information includes quantization information that is set for each travel section of the scheduled travel area and is obtained by actual values of resource consumption of the other vehicle that has travelled through the scheduled travel area being quantized into a plurality of levels. That is, quantization information is set for each travel section of the scheduled travel area, and the actual information includes this quantization information. The data volume of the actual information can thereby be reduced, thus facilitating acquisition of actual information by the information acquisition unit.

(8) In any of (1) to (7) above, a configuration may be adopted in which the information acquisition unit acquires the actual information prior to the vehicle entering the scheduled travel area. For example, the information acquisition unit can be configured to acquire the actual information immediately prior to entering the scheduled travel area or several seconds to several minutes prior to entering the scheduled travel area. Load increases caused by out-of-vehicle wireless communication in the case of the vehicle travelling through the scheduled travel area can thereby be predicted prior to the vehicle entering the scheduled travel area.

(9) In any of (1) to (8) above, a configuration may be adopted in which the information acquisition unit requests the external device to transmit the actual information, prior to the vehicle entering the scheduled travel area. Actual information can thereby be acquired prior to the vehicle entering the scheduled travel area.

(10) In any of (1) to (9) above, a configuration may be adopted in which time information indicating a date and time of generation of the actual information is added to the actual information, and the estimation unit compares the date and time indicated by the time information with a current date and time and estimates the resource consumption that varies temporally with travel of the vehicle, according to a comparison result. Resource consumption can thereby be estimated using actual information whose date and time of creation is more recent, and thus the accuracy of resource consumption estimation can be enhanced.

(11) A server device according to a second aspect of the present disclosure is a server device capable of communicating with an in-vehicle device installed in a vehicle, including an information collection unit configured to collect actual information of resource consumption from a plurality of vehicles, an actual consumption map creation unit configured to receive information relating to a scheduled travel area from the in-vehicle device, and create an actual resource consumption map in which actual resource consumption is set in each travel section of the scheduled travel area, based on the actual information collected by the information collection unit, an execution period extraction unit configured to extract a recommended execution period in which execution of application software that does not require real-time execution of processing is recommended in a travel period through the scheduled travel area, based on the actual resource consumption map, and a notification unit configured to notify the recommended execution period extracted by the execution period extraction unit to the in-vehicle device that transmitted the information relating to the scheduled travel area.

The server device creates the actual resource consumption map by collecting actual information of resource consumption from a plurality of vehicles. The server device extracts a recommended execution period in which execution of application software that does not require real-time performance is recommended, based on the created actual resource consumption map, and notifies the recommended execution period that is extracted to the in-vehicle device. The in-vehicle device distributes the execution period of application software that does not require real-time performance, by allocating the execution period of the application software to the recommended execution period. The in-vehicle device is thereby able to easily suppress a decrease in responsiveness during high load periods caused by out-of-vehicle wireless communication. In this way, the server device, by notifying a recommended execution period of application software that does not require real-time performance to the in-vehicle device, is able to ensure that the in-vehicle device is able to suppress a decrease in responsiveness during high load periods caused by out-of-vehicle wireless communication.

A server device according to another aspect of the present disclosure is a server device capable of communicating with an in-vehicle device installed in a vehicle, including an information collection unit configured to collect actual information of resource consumption from a plurality of vehicles, an actual consumption map creation unit configured to create an actual resource consumption map in which actual resource consumption is set in each travel section of a predetermined area, based on the actual information collected by the information collection unit, and a delivery unit configured to deliver the actual resource consumption map created by the actual consumption map creation unit to the in-vehicle device. The server device, by delivering the actual resource consumption map to the in-vehicle device, is able to support the in-vehicle device so as to be able to suppress a decrease in responsiveness during high load periods caused by out-of-vehicle wireless communication, in the vehicle in which the in-vehicle device is installed.

(12) A resource control method according to a third aspect of the present disclosure is a resource control method in an in-vehicle device installed in a vehicle, including a step of the in-vehicle device acquiring, via a communication unit configured to communicate with an external device, actual information of resource consumption by another vehicle other than the vehicle relating to when the other vehicle travelled through a scheduled travel area of the vehicle, a step of the in-vehicle device estimating resource consumption that varies temporally with travel of the vehicle, in a case of the vehicle travelling through the scheduled travel area, based on the actual information acquired in the acquiring step, and a step of the in-vehicle device controlling resource consumption, by allocating an execution period of predetermined application software to a predetermined period, according to an estimation result in the estimating step. The in-vehicle device is thereby able to suppress a decrease in responsiveness even during high load periods caused by out-of-vehicle wireless communication.

(13) A resource control support method according to a fourth aspect of the present disclosure is a resource control support method to be executed in a server device capable of communicating with an in-vehicle device installed in a vehicle, and for supporting control of resource consumption in the vehicle, including a step of the server device collecting actual information of resource consumption from a plurality of vehicles, a step of the server device receiving information relating to a scheduled travel area from the in-vehicle device, and creating an actual resource consumption map in which actual resource consumption is set in each travel section of the scheduled travel area, based on the actual information collected in the collecting step, a step of the server device extracting a recommended execution period in which execution of application software that does not require real-time execution of processing is recommended in a travel period through the scheduled travel area, based on the actual resource consumption map, and a step of the server device notifying the recommended execution period extracted in the extracting step to the in-vehicle device that transmitted the information relating to the scheduled travel area. The resource control method is thereby able to support the in-vehicle device so as to be able to suppress a decrease in responsiveness during high load periods caused by out-of-vehicle wireless communication.

(14) A computer program according to a fifth aspect of the present disclosure causes a computer installed in a vehicle to function as a communication unit configured to communicate with an external device, an information acquisition unit configured to acquire, via the communication unit, actual information of resource consumption by another vehicle other than the vehicle relating to when the other vehicle travelled through a scheduled travel area of the vehicle, an estimation unit configured to estimate resource consumption that varies temporally with travel of the vehicle, in a case of the vehicle travelling through the scheduled travel area, based on the actual information acquired by the information acquisition unit, and a resource control unit configured to control resource consumption, by allocating an execution period of predetermined application software to a predetermined period, according to an estimation result of the estimation unit. The computer program is thereby able to suppress a decrease in responsiveness during high load periods caused by out-of-vehicle wireless communication.

(15) A computer program according to a sixth aspect of the present disclosure causes a computer to function as an information collection unit configured to collect actual information of resource consumption from a plurality of vehicles, an actual consumption map creation unit configured to receive information relating to a scheduled travel area from an in-vehicle device, and create an actual resource consumption map in which actual resource consumption is set in each travel section of the scheduled travel area, based on the actual information collected by the information collection unit, an execution period extraction unit configured to extract a recommended execution period in which execution of application software that does not require real-time execution of processing is recommended in a travel period through the scheduled travel area, based on the actual resource consumption map, and a notification unit configured to notify the recommended execution period extracted by the execution period extraction unit to the in-vehicle device that transmitted the information relating to the scheduled travel area. The computer program is thereby able to support the in-vehicle device so as to be able to suppress a decrease in responsiveness during high load periods caused by out-of-vehicle wireless communication.

### Detailed Description of Embodiments of Disclosure

Specific examples of an in-vehicle device, a server device, a resource control method, a resource control support method, and a computer program according to embodiments of the present disclosure will be described below with reference to the drawings. Note that, in the following embodiments, the same reference numerals are given to components that are the same. The functions and names of these components are also the same. Accordingly, detailed description thereof will not be repeated.

### First Embodiment

### Overall Configuration

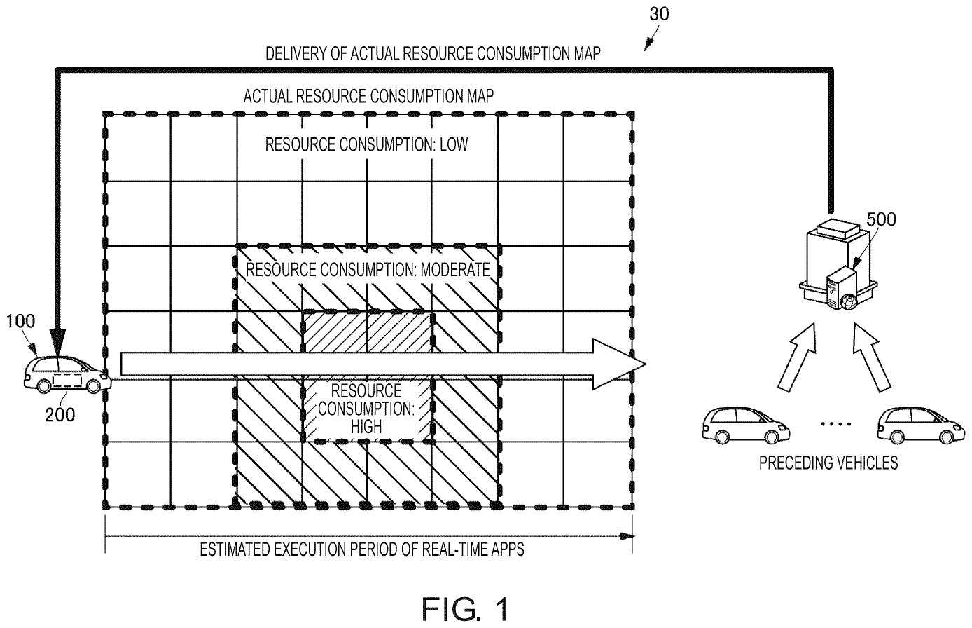

Referring to FIG. 1, a system 30 according to the present embodiment includes an in-vehicle device 200 installed in a vehicle 100 and a server device 500 that communicates with the in-vehicle device 200. The server device 500 is an external device (infrastructure device) installed outside the vehicle. The server device 500 may be a cloud server or an edge server. The vehicle (in-vehicle device) that communicates with the server device 500 is not limited to one vehicle and there may be a plurality of vehicles.

This system 30 predicts load increases in the vehicle 100 caused by out-of-vehicle wireless communication and schedules the execution period of predetermined application software (hereinafter, “application software” will simply be referred to as an “app”). The server device 500 supports prediction of load increases in the in-vehicle device 200, by providing an actual resource consumption map described later to the in-vehicle device 200. The in-vehicle device 200 predicts load increases caused by out-of-vehicle wireless communication, based on the actual resource consumption map provided by the server device 500, and allocates the execution period of the predetermined app to periods in which resources are available. In this way, the in-vehicle device 200, by distributing the execution periods of apps, suppresses a decrease in responsiveness even during high load periods caused by out-of-vehicle wireless communication.

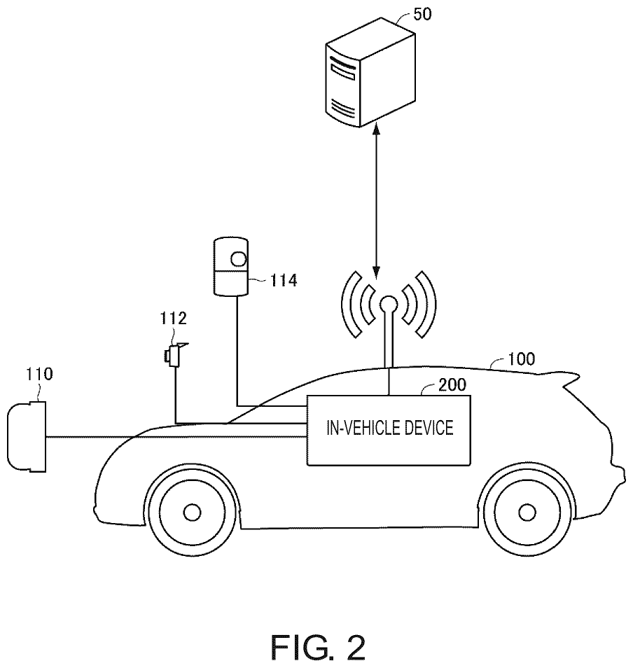

Referring to FIG. 2, the in-vehicle device 200 is also capable of communicating with a server device (infrastructure device 50) other than the server device 500 constituting the system 30. In the vehicle 100 in which the in-vehicle device 200 is installed, various sensors such as a millimeter wave radar 110, an in-vehicle camera 112, and LiDAR (Laser Imaging Detection and Ranging) 114 are installed, in addition to the in-vehicle device 200. For example, the in-vehicle device 200 collects sensor data from these sensors and wirelessly transmits the collected sensor data to the infrastructure device 50 and receives various information including dynamic maps from the infrastructure device 50.

The infrastructure device 50 receives sensor data transmitted from in-vehicle sensors installed in the vehicle, roadside sensors installed in roadside devices, and the like, and creates dynamic maps that are used in driving safety support and the like. The infrastructure device 50 delivers the created dynamic maps to the vehicle.

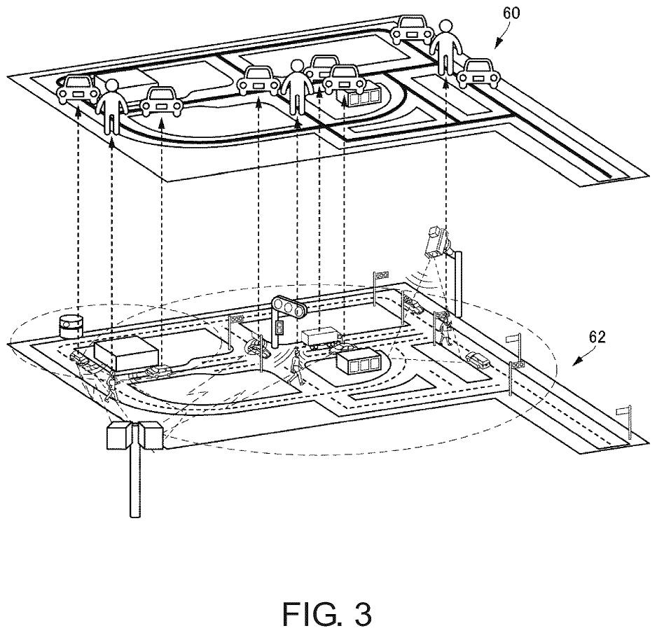

Referring to FIG. 3, a dynamic map 60 is created by detecting moving objects that are present in a real space 62 using a large number of sensors such as LiDAR and cameras, estimating attributes (adult, child, vehicle, motorcycle, etc.) of the moving objects, and using high definition roadmap data prepared in advance in virtual space. The dynamic map 60 includes dynamic information such as surrounding vehicle and pedestrian information, quasi-dynamic information such as accident information and traffic congestion information, quasi-static information such as traffic regulation or road construction schedule information, and static information such as road surface information and lane information (high-precision three-dimensional map information).

Referring again to FIG. 2, the in-vehicle device 200 receives various information including dynamic maps from the infrastructure device 50 and provides various information such as driving safety support to occupants based on the received information. The infrastructure device 50 may be configured to, from a remote location, monitor (remotely monitor) the vehicle 100 in which the in-vehicle device 200 is installed or control (remotely control) the vehicle 100 as necessary.

Due to the in-vehicle device 200 of the vehicle 100 being connected to the infrastructure device 50, it becomes possible to provide various services such as driving safety support to occupants of the vehicle 100. Provision of these services, in the in-vehicle device 200, is realized by execution of service apps in the in-vehicle device 200.

The services that are provided may depend on locational characteristics of the travel area. For example, in the vicinity of an intersection, the in-vehicle device 200 downloads a dynamic map, in order to provide the driver with blind spot information on right turning vehicles, pedestrians and the like. Also, in places such as where there are lots of people or where traffic is congested, for example, the in-vehicle device 200 uploads sensor data collected by the vehicle to the infrastructure device 50 that constructs dynamic maps.

Accordingly, depending on the area through which the vehicle 100 travels, service apps that communicate with the infrastructure device 50 are executed, resulting in an increase in resource consumption in the vehicle 100 due to communication with the infrastructure device 50 provided outside the vehicle. That is, resource consumption increases when the vehicle 100 enters an area where out-of-vehicle communication is necessary. In such a situation, resource consumption in the vehicle 100 not only increases but also varies temporally with travel of the vehicle 100. In view of this, being able to predict temporal variation in resource consumption when travelling through such an area facilitates handling of high loads caused by out-of-vehicle wireless communication.

Referring again to FIG. 1, in order to predict temporal variation in resource consumption, in the present embodiment, the above-described actual resource consumption map is used. An actual resource consumption map is a map showing to what extent resources were actually consumed and the locations (sections) where the resources were consumed, based on the actual resource consumption of the preceding vehicles (vehicles other than the vehicle in which the in-vehicle device 200 is installed) that have previously travelled through the scheduled travel area of the vehicle. The scheduled travel area can, for example, be a specific area in which temporal variation in resource consumption occurs. In this case, the server device 500 that provides actual resource consumption maps can be configured to create an actual resource consumption map for the specific area and provide the created actual resource consumption map to the vehicle that is going to enter the specific area as the scheduled travel area.

The in-vehicle device 200 predicts the temporal variation in resource consumption, by referring to the actual resource consumption map. Additionally, the in-vehicle device 200 estimates resource consumption that varies temporally with travel of the vehicle from data such as the travel speed of the vehicle 100 when travelling through the scheduled travel area. Periods in which resources are available can thereby be predicted, and thus the in-vehicle device 200 allocates the execution period of the predetermined app to periods in which resources are available. The predetermined app is, for example, an app whose processing is executed without being subject to time constraints.

### Example of Service Apps

Apps executed in the in-vehicle device 200 that perform out-of-vehicle communication can be classified into real-time apps that require real-time execution of processing (also referred to as a “high real-time apps”) and non-real-time apps that do not require real-time execution of processing.

Real-time apps require real-time performance, and thus there are restrictions on the execution timing. On the other hand, non-real-time apps do not require real-time performance, and thus there are no restrictions on the execution timing. As such, whether an app is a real-time app or a non-real-time app can be determined by whether real-time performance is required, that is, by whether there is a restriction on the execution timing. Specifically, for example, whether an app is a real-time app or a non-real-time app is determined by whether the app has an allowable delay time or whether the allowable delay time is less than or equal to a predetermined threshold.

Real-time apps can be categorized into the following three groups, for example, according to resource consumption:
(1) First group: Resource consumption (high)

This group includes, for example, real-time apps that remotely control and remotely monitor vehicles, and execute processing such as uploading the sensor data of sensors installed in the vehicle for constructing dynamic maps to a server device (infrastructure device)
(2) Second group: Resource consumption (moderate)

This group includes, for example, real-time apps that execute processing such as downloading dynamic maps (e.g., in cycles of several hundred milliseconds) for sharing dynamic information (blind spot information).
(3) Third group: Resource consumption (low)

This group includes, for example, real-time apps that execute processing such as uploading probe information (e.g., in cycles of several minutes).

Non-real-time apps include, for example, apps that perform processing such as downloading for updating static maps and uploading of vehicle information for troubleshooting.

### Example Estimation of Resource Consumption

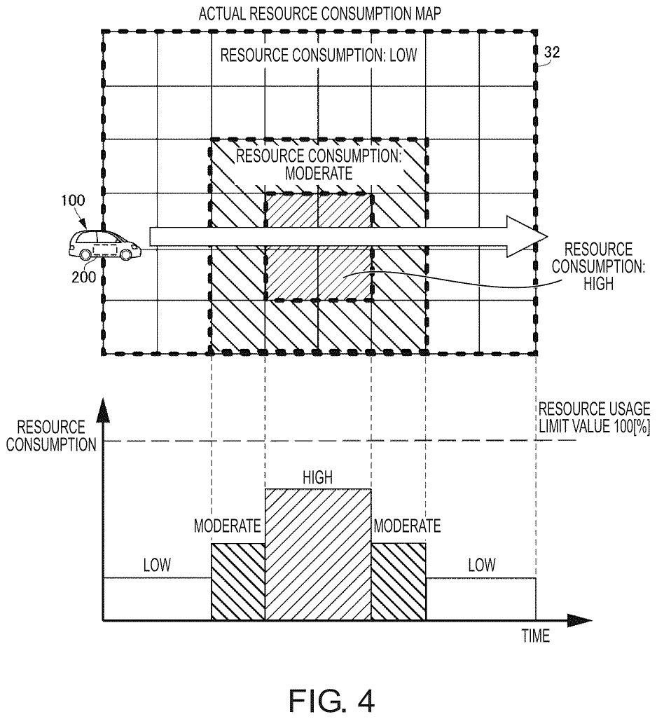

Referring to FIG. 4, the in-vehicle device 200 of the vehicle 100 estimates resource consumption for each travel section in a scheduled travel area 32, based on an actual resource consumption map. In FIG. 4, the upper figure shows the actual resource consumption map, and the lower figure shows the temporal variation in resource consumption estimated based on the actual resource consumption map.

In the actual resource consumption map, a “resource consumption: low” area can, for example, be recognized as an area in which real-time apps belonging to the third group that perform processing such as uploading probe information were mainly executed, a “resource consumption: moderate” area can, for example, be recognized as an area in which real-time apps belonging to the second group that perform processing such as downloading dynamic maps were mainly executed, and a “resource consumption: high” area can, for example, be recognized as an area in which real-time apps belonging to the first group that perform processing such as uploading sensor data were mainly executed.

The in-vehicle device 200 estimates resource consumption that will be required in the case of real-time apps belonging to each group being executed in the vehicle in which the in-vehicle device 200 is installed, for example. Estimation of resource consumption is performed for each consumption estimation target (target resource), for example. The consumption estimation targets are, for example, communication bands (wireless or wired), processors, memories, and the like. By allocating the estimated resource consumption to a travel time zone of each area on the actual resource consumption map, the figure in the lower part of FIG. 4 showing the temporal variation in resource consumption with travel is obtained.

### Scheduling of Non-Real-Time Apps

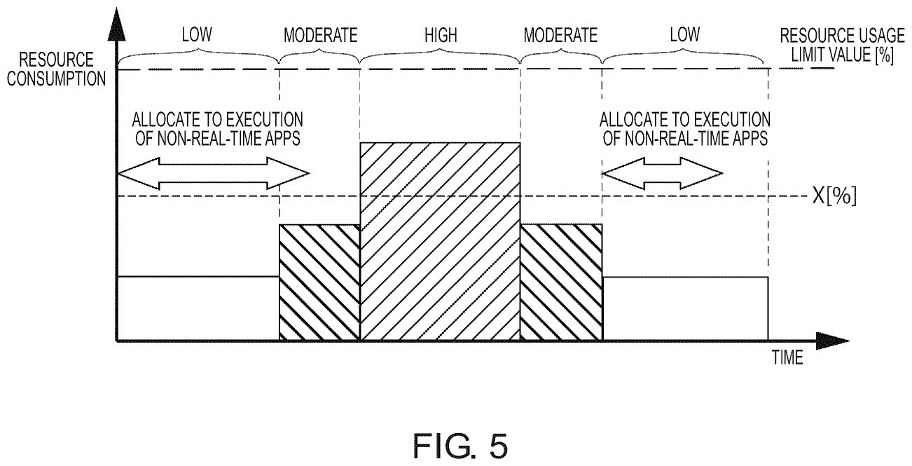

Referring to FIG. 5, it is possible to predict periods in which resources are available from the resource consumption estimation result. For example, if the resource consumption is quantized into a plurality of levels according to resource consumption (here, as an example, three levels “high”, “moderate”, and “low” that correspond to the first to third groups of real-time apps), the periods in which resource consumption is “moderate” and “low” may be predicted as periods in which resources are available. Scheduling of non-real-time apps is possible because there are no restrictions on execution timing, as mentioned above. Thus, the execution period of non-real-time apps is allocated to periods in which resources are predicted to be available.

Note that the prediction of periods in which resources are available may be performed based on the ratio of estimated resource consumption to a resource usage limit. Specifically, periods during which the ratio of the estimated resource consumption to the resource usage limit is less than or equal to a predetermined threshold X [%] may be taken as periods in which resources are available. The threshold X [%] can be set to 50%, for example. The value of the threshold X [%] may be set based on the resource consumption of non-real-time apps. The value of the threshold X [%] is thereby set such that sufficient resources remain to be able to reliably execute non-real-time apps.

### Creation of Actual Resource Consumption Map

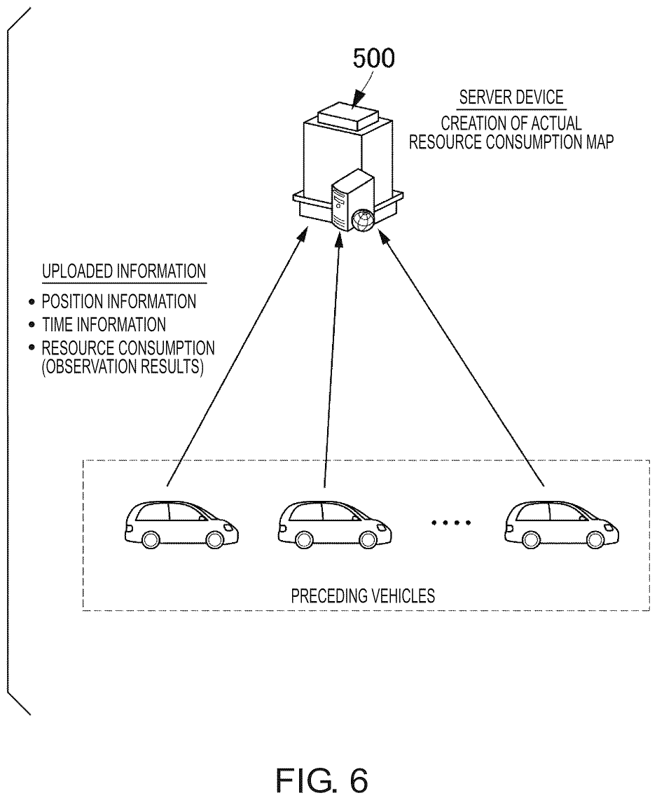

Referring to FIG. 6, the server device 500 collects actual resource consumption values for each real-time app in the travel area (scheduled travel area in the case of vehicle 100) from preceding vehicles. Each preceding vehicle transmits actual travel information (e.g., position information, time information, resource consumption (observation results), etc.) relating to when the preceding vehicle travelled through the travel area (scheduled travel area) to the server device 500 as uploaded information. The server device 500 creates an actual resource consumption map and regularly (e.g., every few minutes) or irregularly updates the actual resource consumption map, based on the collected information.

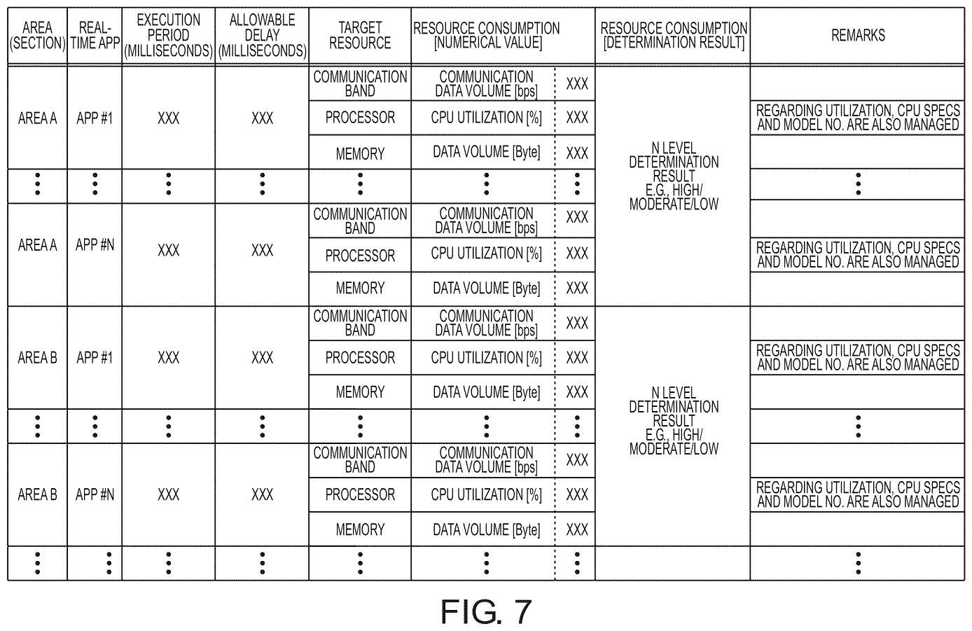

FIG. 7 is a diagram showing an example of the contents of the actual resource consumption map. FIG. 7 shows an example in which the contents of the actual resource consumption map are in tabular form, but the contents need not be in tabular form. Referring to FIG. 7, the table showing the contents of the actual resource consumption map includes the columns “Area (section)”, “Real-time App”, “Execution Period (milliseconds)”, “Allowable Delay (milliseconds)”, “Target Resource”, “Resource Consumption [numerical value]”, “Resource Consumption [determination result]”, and “Remarks”.

In the “Area (section)” column, sections defined by position information are stored. In the “Real-time App” column, identification numbers of real-time apps executed in the respective areas (sections) are stored. In the “Execution Period (milliseconds)” column, execution periods of the real-time apps are stored. The “Allowable Delay (milliseconds)” column, allowable delay times of the real-time apps are stored. In the “Target Resource” column, “communication band”, “processor”, and “memory” are stored as target resource items. In the “Resource Consumption [numerical value]” column, the actual resource consumption value for each target resource item is stored. In the “Resource Consumption [determination result]” column, quantization information obtained by quantizing the results of the actual resource consumption values into N levels is stored. For example, when quantizing the result of the actual resource consumption value into three levels, one of “high”, “moderate”, and “low” is stored. In the “Remarks” column, additional matters and the like are stored as necessary.

The table shown in FIG. 7 is created as actual data of a predetermined period. The time information included in the actual travel information is used when determining whether the information relates to the predetermined period. Note that a configuration may be adopted in which each record has time information by adding a time information column to the table shown in FIG. 7. Furthermore, speed information of the vehicle can be calculated from the time information and the position information, and thus a configuration may be adopted in which each record has speed information by adding a speed information column to the table shown in FIG. 7. The actual resource consumption map may have time information indicating the date and time that the actual resource consumption map was generated added thereto.

The server device 500 (see FIG. 6) may be configured to statistically process and use the contents of the table shown in FIG. 7 as appropriate. For example, values stored in the “Resource Consumption [numerical value]” column may be obtained by statistically processing (averaging) observation values of a plurality of preceding vehicles, or by statistically processing (averaging) temporal variations due to the execution periods of real-time apps.

Note that a configuration may be adopted in which actual travel information is collected from each vehicle regardless of whether the vehicle is a preceding vehicle, and an actual resource consumption map is created or updated by extracting information corresponding to information of preceding vehicles from the collected information.

### Configuration of In-Vehicle Device 200

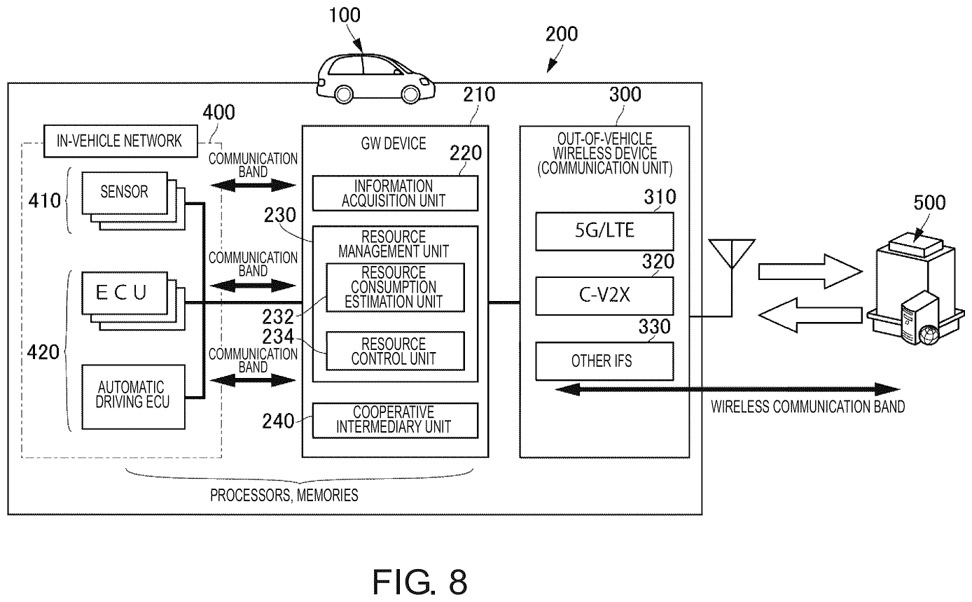

Referring to FIG. 8, the in-vehicle device 200 includes an internal GW device 210 and an out-of-vehicle wireless device 300. In addition to the GW device 210, the vehicle 100 is equipped with an internal network 400, which is a communication network that includes various sensors and various ECUs (Electronic Control Units). Vehicles are usually equipped with a plurality of internal networks. In FIG. 8, the internal network 400 is described as representative of a plurality of internal networks, and the other internal networks are omitted.

The GW device 210 connects the plurality of internal networks including the internal network 400 to each other and organizes the exchange of data between the internal networks. The internal network 400 includes a sensor group 410 that includes various sensors and an ECU group 420 that includes various ECUs. When the vehicle 100 has an automatic driving function, the ECU group 420 includes an automatic driving ECU.

The GW device 210, furthermore, includes an information acquisition unit 220, a resource management unit 230, and a cooperative intermediary unit 240 as functional units. The information acquisition unit 220 acquires actual information of resource consumption in the scheduled travel area by other vehicles (preceding vehicles) that have travelled through the scheduled travel area of the vehicle in which the in-vehicle device 200 is installed (vehicle 100), via the out-of-vehicle wireless device 300. That is, the information acquisition unit 220 acquires, via the out-of-vehicle wireless device 300, actual information of resource consumption by other vehicles, which are vehicles other than the vehicle in which the in-vehicle device 200 is installed (vehicle 100), relating to when these other vehicles travelled through the scheduled travel area of the vehicle in which the in-vehicle device 200 is installed (vehicle 100). In the present embodiment, the information acquisition unit 220 acquires an actual resource consumption map from the server device 500 as actual information. The resource management unit 230 manages resource consumption of the vehicle in which the in-vehicle device 200 is installed. The resource management unit 230 includes a resource consumption estimation unit 232 and a resource control unit 234. The resource consumption estimation unit 232 estimates resource consumption that varies temporally with travel of the vehicle, in the case of the vehicle travelling through the scheduled travel area, based on the actual resource consumption map acquired by the information acquisition unit 220. The resource control unit 234 allocates the execution period of a predetermined app to a predetermined period, according to the estimation result of the resource consumption estimation unit 232. Specifically, as described above, the resource control unit 234 allocates the execution period of non-real-time apps to periods in which resources are predicted to be available.

The cooperative intermediary unit 240 is a functional unit (app) that mediates cooperation between an end ECU and a server device (infrastructure device). The cooperative intermediary unit 240 acquires or updates dynamic map information and transfers the dynamic map information to the end ECU (e.g., automatic driving ECU), for example.

The out-of-vehicle wireless device 300 includes a plurality of wireless interfaces (hereinafter, “interfaces” will be referred to as “IFs”) that perform out-of-vehicle wireless communication. The plurality of wireless IFs include, for example, a wireless IF 310 for performing cellular communication with an external device (out-of-vehicle device) by 5G (fifth generation mobile communication system) or LTE (Long Term Evolution), a wireless IF 320 for performing wireless communication with an external device by C-V2X (Cellular Vehicle-to-Everything), and another wireless IF 330. The other wireless IF 330 is, for example, a local 5G. Note that the wireless IFs included in the out-of-vehicle wireless device 300 are not limited thereto and may be other than wireless IFs. Also, the number of wireless IFs included in the out-of-vehicle wireless device 300 is not limited to the above.

There are various types of wireless IFs compatible with various communication schemes. As communication schemes, cellular communication (4G (LTE)/5G) and LPWA (Low Power Wide Area) are known as wide area communication, and DSRC (Dedicated Short Range Communications) and C-V2X are known as short range communication. Furthermore, as local communication between wide area and short range, there are WiFi, local 5G, and the like. Local 5G differs from cellular 5G in that it is operated independently by companies or municipalities other than telecommunications carriers.

### Resource Management Targets in Vehicle 100

Resource management targets (target resources) include communication resources and computing resources. Communication resource management targets include wired communication bands between the internal network 400 and the GW device 210, wireless communication bands realized by communication between the in-vehicle device 200 and out-of-vehicle devices (e.g., infrastructure device 50, etc.), and relay processing or end processing. Computing resource management targets include processors and memories. The observation domains of resources in the case of communication bands (wired/wireless) are communication links, and in the case of processors and memories are app execution domains.

### Hardware Configuration

### GW Device 210

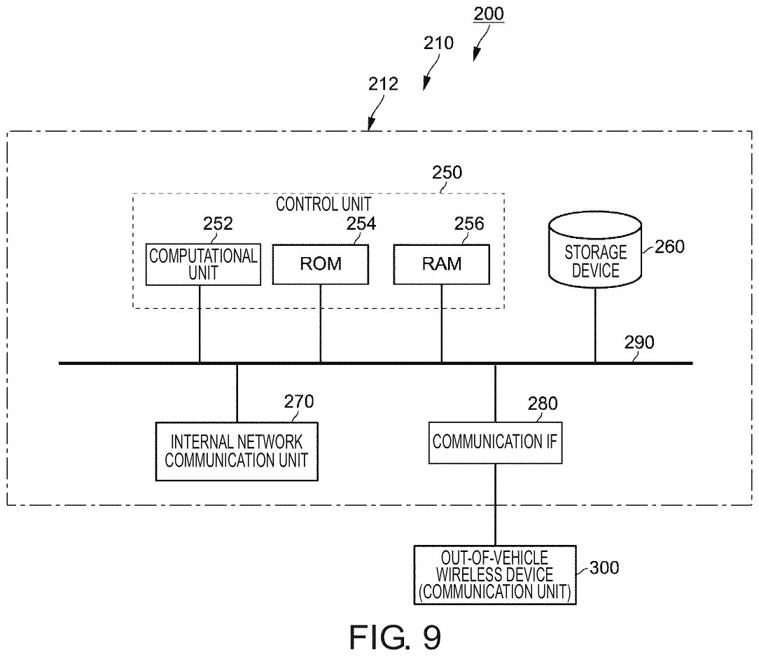

Referring to FIG. 9, the GW device 210 installed in the vehicle 100 includes a computer 212. The computer 212 includes a control unit 250 that performs overall control of the GW device 210, a storage device 260 that stores various data, an internal network communication unit 270 (internal communication outlet) that performs communication with the internal networks, and a communication IF 280 that performs communication with the out-of-vehicle wireless device 300. The control unit 250, the storage device 260, the internal network communication unit 270, and the communication IF 280 are all connected to a bus 290, and data exchange therebetween is performed via the bus 290.

The control unit 250 includes a computational unit 252, a ROM (Read Only Memory) 254 that stores a bootup program of the computer 212 and the like, and a RAM (Random Access Memory) 256 that is readable and writable at any time. The computational unit 252 includes a CPU (Central Processing Unit) or an MPU (Micro Processing Unit), for example, as a computational element (processor). The storage device 260 includes a non-volatile memory such as flash memory, for example. The ROM 254 or the storage device 260 stores software (computer programs) for execution by the computational unit 252 and various information (data).

A computer program for causing the GW device 210 to function as the functional units of the GW device 210 according to the present disclosure is stored and distributed on a predetermined storage medium such as a DVD (Digital Versatile Disc) or USB (Universal Serial Bus) memory and is further transferred therefrom to the storage device 260. Alternatively, the computer program may be transmitted from an external device to the computer 212 by out-of-vehicle wireless communication and stored in the storage device 260.

The functions of the functional units of the GW device 210 are realized by software processing that is executed by the control unit 250 using hardware. Some or all of these functions may be realized by an integrated circuit including a microcomputer.

The internal network communication unit 270 provides an IF for communicating with the internal networks. The internal network communication unit 270 performs communication with the internal networks, in accordance with communication protocols such as CAN (Controller Area Network), for example. A plurality of internal network communication units 270 are provided in correspondence with the plurality of internal networks. The GW device 210 (computer 212) relays data between the internal networks by transmitting data (messages) received by one internal network communication unit from another internal network communication unit, under the control of the control unit 250. The communication IF 280 provides an IF for communicating with the out-of-vehicle wireless device 300.

### Server Device 500

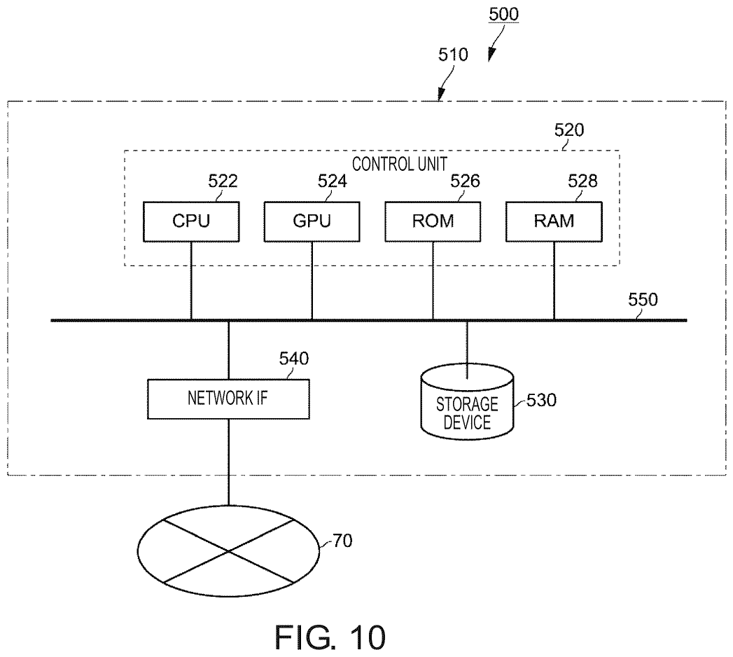

Referring to FIG. 10, the server device 500 includes a computer 510. The computer 510 includes a control unit 520, a storage device 530, and a network IF 540. The control unit 520 includes a CPU 522, a GPU (Graphics Processing Unit) 524, a ROM 526, and a RAM 528. The control unit 520, the storage device 530, and the network IF 540 are all connected to a bus 550, and data exchange therebetween is performed via the bus 550.

The storage device 530 includes a non-volatile storage device such as a flash memory or a hard disk drive, for example. The storage device 530 stores a computer program for execution by the CPU 522 and various information. The network IF 540 provides a connection to a network 70 that enables communication with other terminals.

The server device 500 acquires actual travel information (e.g., position information, time information, resource consumption (observation results), etc.) for creating an actual resource consumption map from preceding vehicles via the network 70. The server device 500 creates the actual resource consumption map by processing the acquired actual travel information. The server device 500 delivers the created actual resource consumption map to the vehicle via the network 70.

A computer program for causing the server device 500 to function as the functional units of the server device 500 according to the present embodiment is stored and distributed on a predetermined storage medium such as a DVD or USB memory and is further transferred therefrom to the storage device 530. Alternatively, the computer program may be transmitted from an external device to the computer 510 via the network 70 and stored in the storage device 530.

### Functional Configuration of Server Device 500

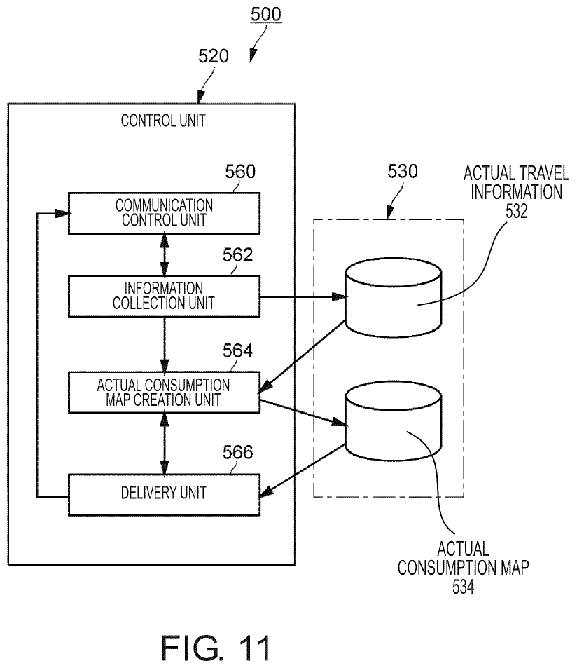

Referring to FIG. 11, the control unit 520 of the server device 500 includes a communication control unit 560, an information collection unit 562, an actual consumption map creation unit 564, and a delivery unit 566 as functional units. The storage device 530 includes an actual travel information storage unit 532 and an actual consumption map storage unit 534. The communication control unit 560 controls the network IF 540 (see FIG. 10) in order to communicate with external devices. The information collection unit 562 collects actual travel information from a plurality of preceding vehicles and stores the collected actual travel information in the actual travel information storage unit 532. The actual consumption map creation unit 564 reads out and processes the actual travel information stored in the actual travel information storage unit 532 and creates an actual resource consumption map. The actual consumption map creation unit 564 stores the created actual resource consumption map in the actual consumption map storage unit 534. The actual consumption map creation unit 564 also has a function of updating the actual resource consumption map, based on newly collected actual travel information. The delivery unit 566 reads out the actual resource consumption map from the actual consumption map storage unit 534 at a predetermined timing and delivers the actual resource consumption map to the vehicle.

These functions are realized by software processing that is executed by the control unit 250 using hardware. Some or all of these functions may be realized by an integrated circuit including a microcomputer.

### Software Configuration

### In-Vehicle Device 200

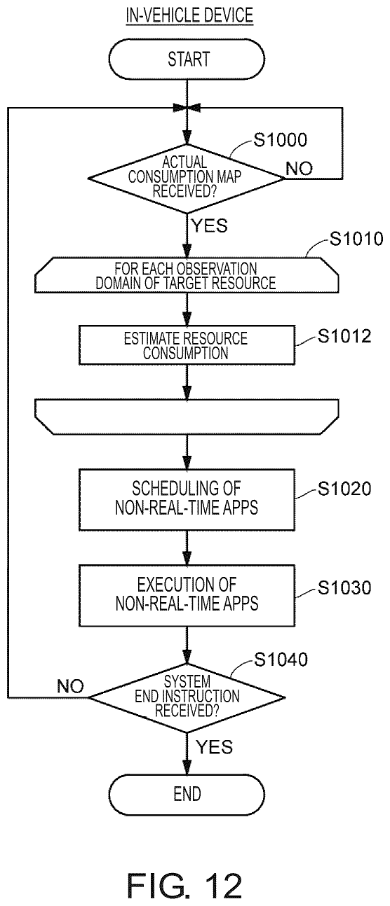

Referring to FIG. 12, the control structure of a computer program that is executed in the in-vehicle device 200 in order to suppress a decrease in responsiveness even during high load periods caused by out-of-vehicle wireless communication will be described. This program is started following the start of out-of-vehicle wireless communication, for example.

This program includes step S1000 that involves waiting to receive an actual resource consumption map from the server device 500, and step S1010 that is executed when an actual resource consumption map is received from the server device 500 in step S1000, and involves repeating step S1012 described below until the processing on all target resources ends for each of the observation domains of the target resources. Step S1010 includes step S1012 that involves estimating the resource consumption of real-time apps in the scheduled travel area, based on the received actual resource consumption map.

This program, furthermore, includes step S1020 that is executed after step S1010, and involves scheduling the execution period of non-real-time apps, based on the resource consumption estimation result, step S1030 that is executed after step S1020, and involves executing non-real-time apps in the execution period set in the scheduling processing of step S1020, and step S1040 that is executed after step S1030, and involves determining whether a system end instruction has been given, and branching the flow of control according to the determination result. If it is determined in step S1040 that the system end instruction has not been given (“NO”), control returns to step S1000. If it is determined in step S1040 that the system end instruction has been given (“YES”), this program ends.

### Server Device 500

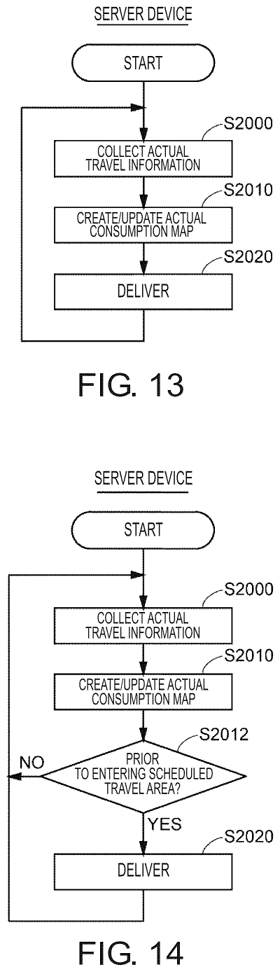

The control structure of a computer program that is executed in the server device 500 in order to create an actual resource consumption map and deliver the created actual resource consumption map to the vehicle will be described with reference to FIG. 13. This program is, for example, started by an operation of an administrator who manages the server device 500.

This program includes step S2000 that involves collecting actual travel information (e.g., position information, time information, resource consumption (observation results), etc.) for creating an actual resource consumption map from each vehicle (preceding vehicle), step S2010 that is executed after step S2000, and involves creating or updating an actual resource consumption map, based on the collected information, and step S2020 that is executed after step S2010, and involves delivering the created or updated actual resource consumption map to the vehicle 100 (in-vehicle device 200), and returning control to step S2000.

### Operations

The system 30 according to the present embodiment operates as follows. Hereinafter, the case where a specific area in which a temporal variation in resource consumption occurs is given as the scheduled travel area will be described.

Referring to FIG. 1, the server device 500 collects actual resource consumption values for each real-time app in the travel area (specific area) from preceding vehicles that have travelled through the specific area. Specifically, each preceding vehicle transmits actual travel information (e.g., position information, time information, resource consumption (observation results), etc.) relating to when the preceding vehicles travelled through the travel area to the server device 500 as uploaded information. The server device 500 collects actual travel information including actual resource consumption values, by receiving the uploaded information from the preceding vehicles (step S2000 in FIG. 13).

The server device 500 creates an actual resource consumption map based on the collected actual travel information (step S2010) and delivers the created actual resource consumption map to the vehicle 100 (in-vehicle device 200) (step S2020).

Upon receiving the actual resource consumption map (YES in step S1000 in FIG. 12), the in-vehicle device 200 of the vehicle 100 estimates resource consumption that varies temporally with travel of the vehicle, in the case of the vehicle travelling through the scheduled travel area, based on the received actual resource consumption map (step S1010 in FIG. 12).

Referring to FIG. 4, specifically, the in-vehicle device 200 estimates the resource consumption of real-time apps in the scheduled travel area, based on the received actual resource consumption map. The in-vehicle device 200 schedules the execution period of non-real-time apps, based on the resource consumption estimation result (step S1020 in FIG. 12). Referring to FIG. 5, periods in which resources are available are extracted, based on the resource consumption estimation result. The in-vehicle device 200 allocates the execution period of non-real-time apps to periods in which resources are available. The in-vehicle device 200 executes processing of the non-real-time apps during the execution period of the non-real-time apps (step S1030 in FIG. 12).

As is clear from the above description, the in-vehicle device 200 and the server device 500 according to the present embodiment achieve the effects mentioned below.

The in-vehicle device 200 acquires actual information (in the present embodiment, an actual resource consumption map) of resource consumption in the scheduled travel area of the vehicle by other vehicles (preceding vehicles) that have travelled through the scheduled travel area. The in-vehicle device 200 estimates resource consumption that varies temporally with travel of the vehicle, based on the acquired actual resource consumption map. That is, the in-vehicle device 200 predicts load increases caused by out-of-vehicle wireless communication in the case of the vehicle travelling through the scheduled travel area, based on this actual resource consumption map. The in-vehicle device 200, furthermore, controls resource consumption, by allocating the execution period of a predetermined app (non-real-time app) to, for example, periods outside of high load periods. The in-vehicle device 200 is thereby able to suppress a decrease in responsiveness even during high load periods caused by out-of-vehicle wireless communication. Additionally, it is possible to suppress the occurrence of services that cannot meet allowable delay times, without installing a high-performance processor in the in-vehicle device. As a result, it is possible to suppress a decrease in responsiveness while suppressing an increase in the cost of the in-vehicle device.

The in-vehicle device 200 estimates, for each travel section, resource consumption including resource consumption due to execution of real-time apps, which varies according to the travel section of the scheduled travel area, and allocates the execution period of non-real-time apps to predetermined periods according to the estimation result. The execution period of non-real-time apps can thereby be allocated to periods in which resources are available. That is, it is possible to prevent non-real-time apps from being executed during periods in which resource consumption increases due to execution of real-time apps. The execution periods of apps can thereby be distributed, thus enabling a decrease in responsiveness to be easily suppressed during high load periods caused by out-of-vehicle wireless communication.

The server device 500 collects actual resource consumption values (actual travel information) from a plurality of preceding vehicles and creates an actual resource consumption map in which actual resource consumption is set in each travel section of the scheduled travel area, based on the collected actual travel information. The in-vehicle device 200 is able to easily estimate resource consumption that varies temporally with travel of the vehicle, by using the actual resource consumption map provided by the server device 500.

When scheduling the execution period of non-real-time apps, the execution period of the non-real-time apps can also be allocated to scheduled travel periods of travel sections in which the ratio of the estimated resource consumption to the resource usage limit is less than or equal to a predetermined threshold X [%]. In this case, the execution period of the non-real-time apps can be easily set to periods other than high load periods. The value of the threshold X [%] may be set based on the resource consumption of non-real-time apps. The execution period of non-real-time apps can thereby be set to periods in which resources for executing the non-real-time apps are secured.

The actual resource consumption map includes quantization information (e.g., “high”, “moderate”, “low”) that is set for each travel section of the scheduled travel area and is obtained by actual values of resource consumption in the scheduled travel area by preceding vehicles that have travelled through the scheduled travel area being quantized into a plurality of levels (three levels in the present embodiment). The data volume in the actual resource consumption map can thereby be reduced, thus facilitating acquisition of an actual resource consumption map by the in-vehicle device 200.

### First Variation

In the system according to a first variation, the server device that delivers actual resource consumption maps monitors the current position of the vehicle that is the delivery destination and delivers an actual resource consumption map to the vehicle prior to the vehicle entering the scheduled travel area. The server device acquires position information of the vehicle (in-vehicle device) by communicating with the vehicle (in-vehicle device). The server device determines whether the vehicle that is the delivery destination is prior to entering the scheduled travel area, based on the acquired position information.

The scheduled travel area of the vehicle is set in the server device as the specific area described above. The server device determines whether the vehicle is prior to entering the specific area set as the scheduled travel area and delivers the actual resource consumption map to the vehicle according to the determination result. Prior to entering the scheduled travel area can be, for example, immediately prior to entering the scheduled travel area, several seconds prior to entering the scheduled travel area, or several minutes prior to entering the scheduled travel area. Note that it is possible to calculate the time until the scheduled travel area is entered from position information, vehicle speed, and the like.

An in-vehicle device installed in the vehicle thereby receives the actual resource consumption map from the server device prior to entering the scheduled travel area. The remaining configuration of the in-vehicle device and the server device is similar to the first embodiment described above.

### Software Configuration

In the server device according to the first variation, a program shown in FIG. 14 is executed, instead of the program shown in FIG. 13. The program of FIG. 14 further adds step S2012 to the program of FIG. 13. The processing of step S2000, step S2010, and step S2020 in FIG. 14 is the same as the processing of the respective steps shown in FIG. 14. The differences will be described below.

Referring to FIG. 14, this program includes step S2012 that is executed after step S2010, and involves determining whether the vehicle (in-vehicle device) to which the actual resource consumption map is to be provided is prior to entering a specific area (scheduled travel area) and branching the flow of control according to the determination result. If it is determined in step S2012 that the vehicle is not prior to entering the specific area, control returns to step S2000. If it is determined in step S2012 that the vehicle is prior to entering the specific area, control proceeds to step S2020.

With such a configuration, the in-vehicle device is able to more reliably acquire an actual resource consumption map from the server device prior to entering the scheduled travel area. Load increases caused by out-of-vehicle wireless communication in the case of the vehicle travelling through a scheduled travel area can thereby be predicted prior to the vehicle entering the scheduled travel area.

Other effects of the first variation are similar to the first embodiment described above.

### Second Variation

In the system according to a second variation, an in-vehicle device requests the server device to transmit an actual resource consumption map. In response to the transmission request from the in-vehicle device, the server device delivers an actual resource consumption map to the in-vehicle device that transmitted the transmission request. For example, the in-vehicle device transmits a transmission request to the server device at any desired timing prior to the vehicle entering the scheduled travel area. The in-vehicle device is thereby able to receive an actual resource consumption map from the server device, prior to the vehicle entering the scheduled travel area. The remaining configuration of the in-vehicle device and the server device is similar to the first embodiment described above.

### Software Configuration

### In-Vehicle Device

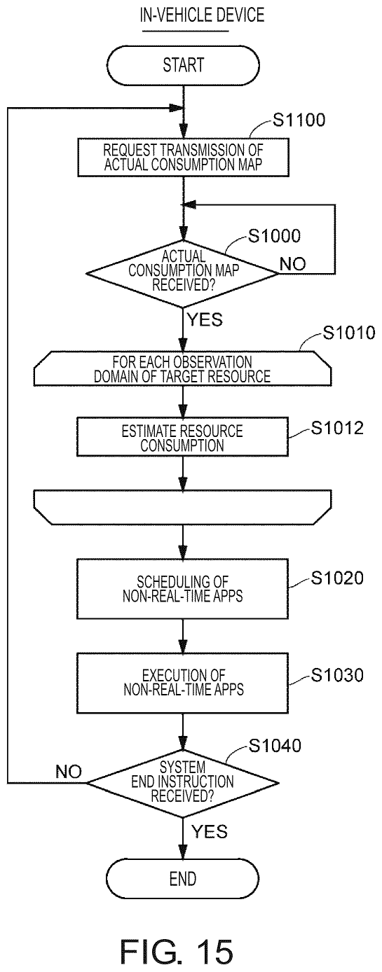

In the in-vehicle device according to the second variation, a program shown in FIG. 15 is executed, instead of the program shown in FIG. 12. The program of FIG. 15 further adds step S1100 to the program of FIG. 12. The processing of step S1000 to step S1040 in FIG. 15 is the same as the processing of the respective steps shown in FIG. 12. The differences will be described below.

Referring to FIG. 15, this program includes step S1100 that involves requesting the server device that delivers actual resource consumption maps to transmit an actual resource consumption map. In step S1100, a transmission request requesting transmission of the actual resource consumption map is transmitted to the server device from the in-vehicle device, at a predetermined timing prior to the vehicle entering the scheduled travel area, for example. When the processing of step S1100 ends, control proceeds to step S1000. If it is determined in step S1040 that the system end instruction has not been given (“NO”), control returns to step S1100.

### Server Device

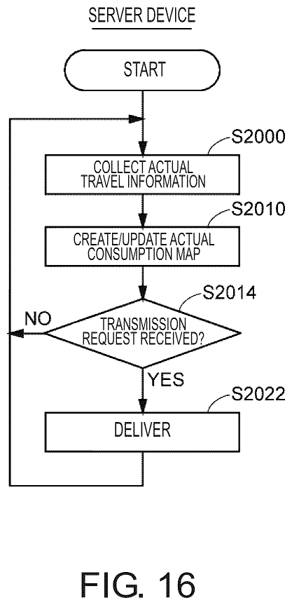

In the server device according to the second variation, a program shown in FIG. 16 is executed, instead of the program shown in FIG. 13. The program of FIG. 16 includes step S2014 and step S2022, instead of step S2020, in the program of FIG. 13. The processing of step S2000 and step S2010 in FIG. 16 is the same as the processing of the respective steps shown in FIG. 13. The differences will be described below.

Referring to FIG. 16, this program includes step S2014 that is executed after step S2010, and involves determining whether a transmission request has been received from an in-vehicle device, and branching the flow of control according to the determination result, and step S2022 that is executed if it is determined in step S2014 that a transmission request has been received, and involves delivering (transmitting) an actual resource consumption map to the in-vehicle device (vehicle) that transmitted the transmission request.

If it is determined in step S2014 that a transmission request has not been received or the processing of step S2022 has ended, control returns to step S2000.

In this way, the in-vehicle device, by requesting the server device to transmit an actual resource consumption map, prior to the vehicle entering the scheduled travel area, is able to acquire an actual resource consumption map from the server device prior to the vehicle entering the scheduled travel area.

Other effects of the second variation are similar to the first embodiment.

### Third Variation

In the system according to a third variation, an in-vehicle device notifies a scheduled travel area of the vehicle to the server device. The scheduled travel area may be set based on a destination that is set (input) in a navigation system or the like by an occupant of the vehicle, for example. In this case, a route to the set (input) destination is determined, and the scheduled travel area is derived according to the determined route. Furthermore, when a destination is not input, the scheduled travel area may be set based on past driving history, current travel behavior of the vehicle, and the like, for example. When notification is received from an in-vehicle device, the server device selects or creates an actual resource consumption map that depends on the scheduled travel area that is transmitted and delivers the actual resource consumption map to the in-vehicle device that transmitted the notification. The timing at which the in-vehicle device notifies the scheduled travel area of the vehicle to the server device is not particularly limited. As an example, the timing for notifying the scheduled travel area of the vehicle can be any desired timing prior to the vehicle entering the scheduled travel area, similarly to the second variation. The remaining configuration of the in-vehicle device and the server device is similar to the first embodiment described above.

### Software Configuration

### In-Vehicle Device

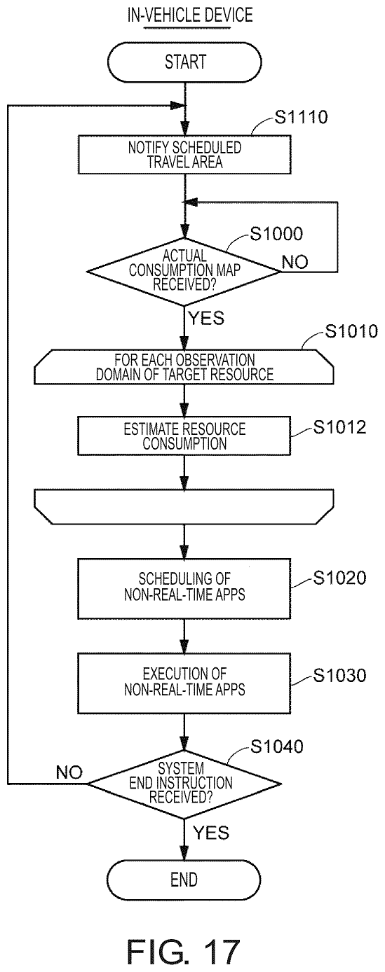

In the in-vehicle device according to the third variation, a program shown in FIG. 17 is executed, instead of the program shown in FIG. 12. The program of FIG. 17 further adds step S1110 to the program of FIG. 12. The processing from step S1000 to step S1040 in FIG. 17 is the same as the processing of the respective steps shown in FIG. 12. The differences will be described below.

Referring to FIG. 17, this program includes step S1110 that involves notifying the scheduled travel area of the vehicle to the server device that delivers actual resource consumption maps. When the processing of step S1110 ends, control proceeds to step S1000. If it is determined in step S1040 that the system end instruction has not been given (“NO”), control returns to step S1110.

### Server Device

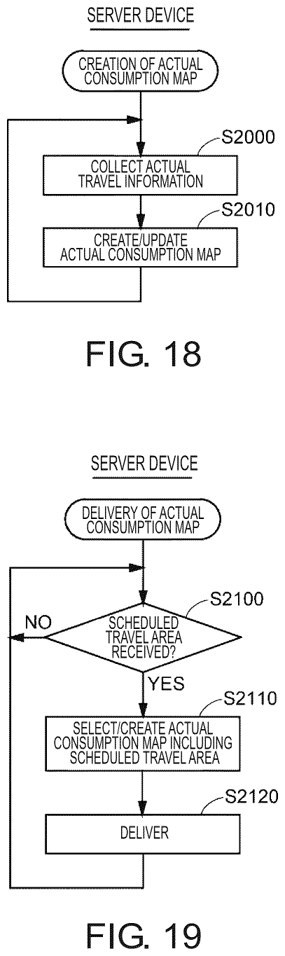

In the server device according to the third variation, programs shown in FIG. 18 and FIG. 19 are executed, instead of the program shown in FIG. 13. The program shown in FIG. 18 is executed in parallel with the program shown in FIG. 19.

Referring to FIG. 18, this program includes step S2000 that involves collecting actual travel information (e.g., position information, time information, and resource consumption (observation results)) for creating an actual resource consumption map from each vehicle (preceding vehicle), and step S2010 that is executed after step S2000, and involves creating or updating an actual resource consumption map, based on the collected information. When the processing of step S2010 ends, control returns to step S2000.

Referring to FIG. 19, this program includes step S2100 that involves waiting to receive notification of a scheduled travel area from a vehicle, step S2110 that is executed if it is determined in step S2100 that notification of a scheduled travel area has been received, and involves selecting an actual resource consumption map corresponding to the scheduled travel area that is notified from among created actual resource consumption maps or creating an actual resource consumption map corresponding to the scheduled travel area that is notified, and step S2120 that is executed after step S2110, and involves transmitting (delivering) the actual resource consumption map corresponding to the scheduled travel area that is notified to the vehicle (vehicle that transmitted the notification). When the processing of step S2120 ends, control returns to step S2100.

In the system according to the third variation, the in-vehicle device notifies the scheduled travel area of the vehicle in which the in-vehicle device is installed to the server device and acquires an actual resource consumption map that corresponds to the scheduled travel area from the server device. The in-vehicle device is thereby able to predict temporal variation in resource consumption associated with travel of the vehicle for a variety of scheduled travel areas.

Other effects of the third variation are similar to the first embodiment described above.

### Fourth Variation

In the system according to a fourth variation, the elapsed time from when the actual resource consumption map was created is calculated, and the in-vehicle device executes resource consumption estimation processing that uses the actual resource consumption map, according to the elapsed time. That is, if the actual resource consumption map acquired by the in-vehicle device is old, resource consumption estimation processing using that actual resource consumption map is not performed, and if the actual resource consumption map is relatively new, resource consumption estimation processing is executed.

Time information indicating the date and time that the actual resource consumption map was generated is added to the actual resource consumption map. The in-vehicle device compares the date and time indicated by the time information with the current date and time and estimates resource consumption that varies temporally with travel of the vehicle, according to the comparison result. For example, if the comparison result indicates that a time period longer than a predetermined time period (e.g., a time period within a range from 2 hours to 6 hours) has elapsed from when the actual resource consumption map was generated, the in-vehicle device does not execute estimation processing using that actual resource consumption map. Resource consumption can thereby be estimated using actual information whose date and time of creation is more recent, and thus the accuracy of resource consumption estimation can be enhanced.

### Software Configuration

### In-Vehicle Device

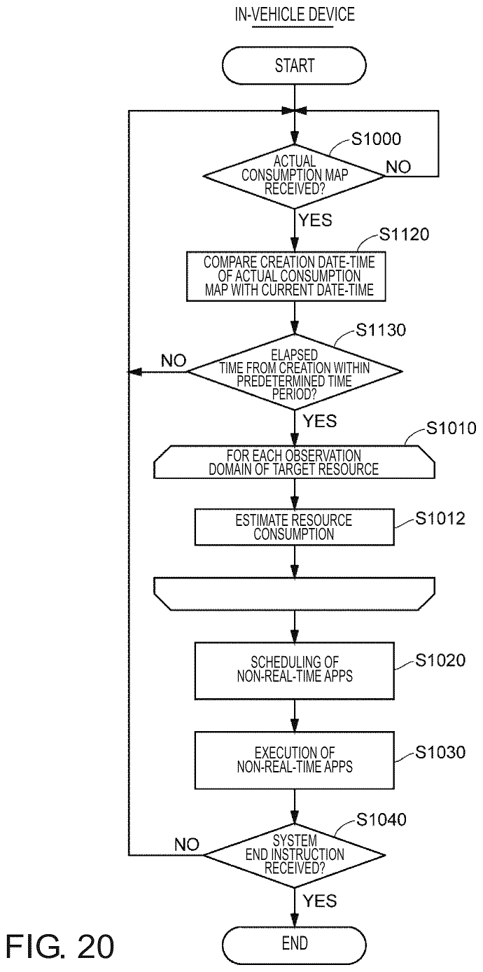

In the in-vehicle device according to the fourth variation, a program shown in FIG. 20 is executed, instead of the program shown in FIG. 12. The program of FIG. 20 further adds step S1120 and step S1130 to the program of FIG. 12. The processing from step S1000 to step S1040 in FIG. 20 is the same as the processing of the respective steps shown in FIG. 12. The differences will be described below.

Referring to FIG. 20, this program includes step S1120 that is executed if it is determined in step S1000 that an actual resource consumption map has been received from the server device, and involves comparing the date and time of creation of the received actual resource consumption map with the current date and time, and step S1130 that is executed after step S1120, and involves determining whether the elapsed time from when the actual resource consumption map was created is within a predetermined time period (i.e., time period within a range from 2 hours to 6 hours) and branching the flow of control according to the determination result. If it is determined in step S1130 that the elapsed time from when the actual resource consumption map was created is not within the predetermined time period (i.e., a time period longer than the predetermined time has elapsed), control returns to step S1000. If it is determined in step S1130 that the elapsed time from when the actual resource consumption map was created is within the predetermined time period, control proceeds to step S1010.

Note that the in-vehicle device may be configured to, in the case where a time longer than the predetermined time period has elapsed from when the actual resource consumption map was generated, discard that actual resource consumption map and request the server device to transmit a new actual resource consumption map.

### Second Embodiment

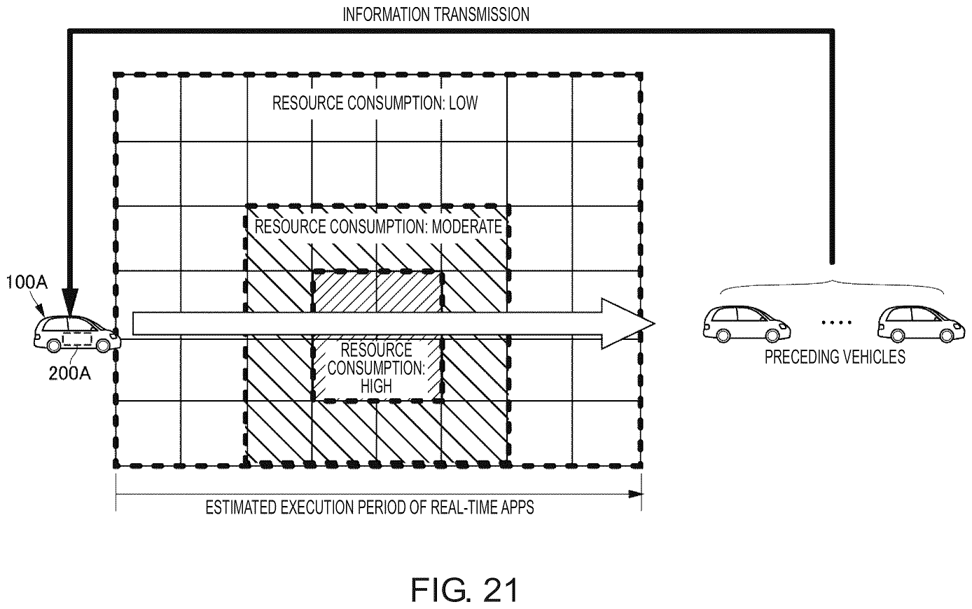

Referring to FIG. 21, the present embodiment differs from the first embodiment in which resource consumption is estimated based on an actual resource consumption map acquired from a server device, in that an in-vehicle device 200A according to the present embodiment acquires actual travel information (e.g., position information, time information, resource consumption (observation results), etc.) from preceding vehicles, and estimates resource consumption that varies temporally with travel of the vehicle, based on the acquired actual travel information. The remaining configuration is similar to the first embodiment.

The in-vehicle device 200A of a vehicle 100A communicates by vehicle-to-vehicle communication with a plurality of preceding vehicles (e.g., two to three vehicles) that have already travelled through the scheduled travel area and acquires actual travel information from these preceding vehicles. The in-vehicle device 200A determines which real-time apps have been executed, for each travel section of the scheduled travel area, by processing the acquired actual travel information. The in-vehicle device 200A estimates the resource consumption of real-time apps in the scheduled travel area, in a similar manner to the first embodiment, based on the determination result. The in-vehicle device 200A, furthermore, schedules the execution period of non-real-time apps, based on the resource consumption estimation result.

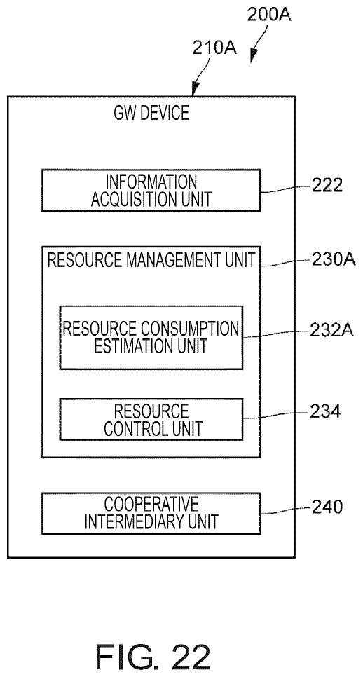

Referring to FIG. 22, the in-vehicle device 200A according to the present embodiment includes a GW device 210A, instead of the GW device 210 (see FIG. 8). The GW device 210A includes an information acquisition unit 222 and a resource management unit 230A, instead of the information acquisition unit 220 and the resource management unit 230 (see FIG. 8), respectively. The information acquisition unit 222 acquires “actual travel information” which is actual information of resource consumption in the scheduled travel area from preceding vehicles that have travelled through the scheduled travel area of the vehicle in which the in-vehicle device 200A is installed, via the out-of-vehicle wireless device 300 (see FIG. 8). The resource management unit 230A includes a resource consumption estimation unit 232A, instead of the resource consumption estimation unit 232 (see FIG. 8). The resource consumption estimation unit 232A estimates resource consumption for each travel section of the scheduled travel area, based on the actual travel information acquired from the preceding vehicles.

### Software Configuration

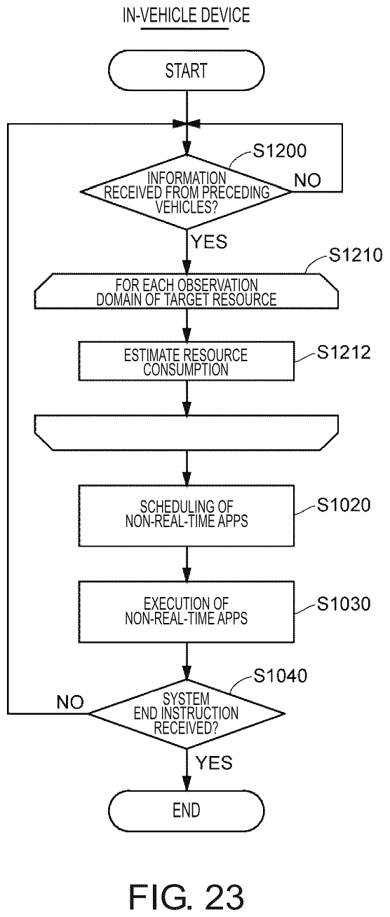

In the in-vehicle device 200A according to the present embodiment, a program shown in FIG. 23 is executed, instead of the program shown in FIG. 12. The program of FIG. 23 includes step S1200 and step S1210, instead of step S1000 and step S1010, in the program of FIG. 12. The processing from step S1020 to step S1040 in FIG. 23 is the same as the processing of the respective steps shown in FIG. 12. The differences will be described below.

Referring to FIG. 23, this program includes step S1200 that involves waiting for actual travel information to be received from a plurality of preceding vehicles, and step S1210 that is executed if it is determined in step S1200 that actual travel information has been received from a plurality of preceding vehicles, and involves repeating step S1212 described below until the processing on all target resources ends for each of the observation domains of the target resources. Step S1210 includes step S1212 that involves estimating the resource consumption of real-time apps in the scheduled travel area, based on the received actual travel information. When the processing of step S1210 ends, control proceeds to step S1020.

In the present embodiment, actual travel information acquired from preceding vehicles is used in estimating resource consumption, instead of an actual resource consumption map acquired from a server device. The in-vehicle device 200A can thereby similarly estimate resource consumption that varies temporally with travel of the vehicle in an easy manner. Thus, a decrease in responsiveness during high load periods caused by out-of-vehicle wireless communication can be easily suppressed.

Other effects of the present embodiment are similar to the first embodiment described above.

### Third Embodiment

The system according to the present embodiment differs from the first embodiment in that the server device extracts a period in which resources of the vehicle are available and notifies the extracted period to the vehicle as a recommended execution period in which execution of non-real-time apps is recommended. That is, in the present embodiment, processing up to extraction of periods for allocating the execution period of non-real-time apps is executed in the server device.

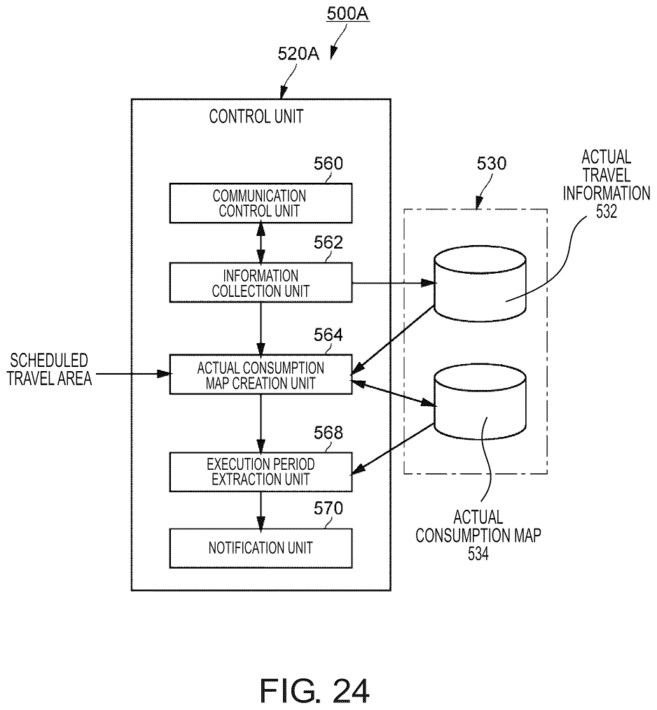

Referring to FIG. 24, a server device 500A according to the present embodiment includes a control unit 520A, instead of the control unit 520 (see FIG. 11). The control unit 520A includes an execution period extraction unit 568 and a notification unit 570 as functional units, instead of the delivery unit 566 (see FIG. 11). The server device 500A receives information relating to a scheduled travel area and resource management targets that is transmitted from an in-vehicle device. The actual consumption map creation unit 564 creates an actual resource consumption map that corresponds to the scheduled travel area and stores the created actual resource consumption map in the actual consumption map storage unit 534. The execution period extraction unit 568 extracts a recommended execution period in which execution of non-real-time apps is recommended in the travel period through the scheduled travel area, based on the actual resource consumption map. Specifically, the execution period extraction unit 568 estimates the resource consumption of real-time apps in the scheduled travel area, based on the actual resource consumption map and information relating to the resource management target. The execution period extraction unit 568, furthermore, extracts, as a recommended execution period, a period in which sufficient resources are available for execution of non-real-time apps, based on the resource consumption estimation result. The notification unit 570 notifies the recommended execution period for non-real-time apps extracted by the execution period extraction unit 568 to the in-vehicle device that transmitted the information relating to the scheduled travel area and the like.

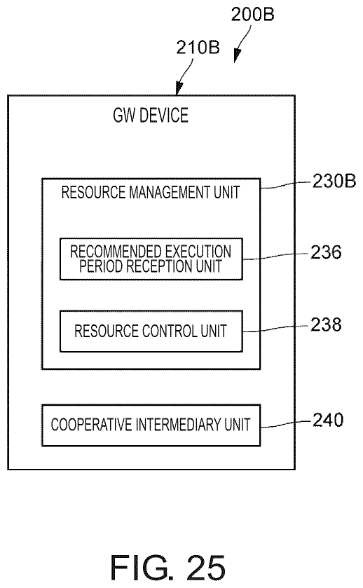

Referring to FIG. 25, an in-vehicle device 200B according to the present embodiment includes a GW device 210B, instead of the GW device 210 (see FIG. 8). In the GW device 210B, the information acquisition unit 220 (see FIG. 8) is omitted, and a resource management unit 230B is included, instead of the resource management unit 230 (see FIG. 8). The resource management unit 230B includes a recommended execution period reception unit 236 and a resource control unit 238. The recommended execution period reception unit 236 receives the recommended execution period notified from the server device 500A (see FIG. 24). The resource control unit 238 allocates the execution period of non-real-time apps to the recommended execution period.

The hardware configuration of the server device 500A and the in-vehicle device 200B is similar to the first embodiment.

### Software Configuration

### Server Device 500A

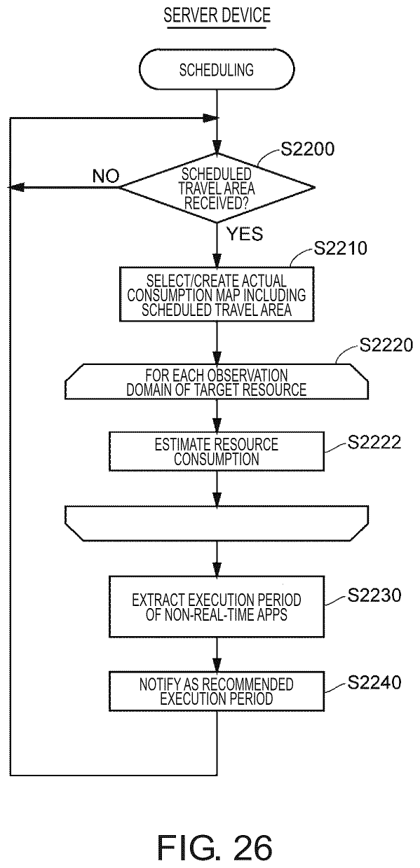

In the server device 500A according to the present embodiment, programs shown in FIG. 18 and FIG. 26 are executed, instead of the program shown in FIG. 13. The program shown in FIG. 26 is executed in parallel with the program shown in FIG. 18. Description of the program shown in FIG. 18 is omitted.

Referring to FIG. 26, this program includes step S2200 that involves waiting to receive information relating to a scheduled travel area and resource management targets from the in-vehicle device 200B, step S2210 that is executed if it is determined in step S2200 that information relating to a scheduled travel area and resource management targets has been received, and involves selecting an actual resource consumption map that corresponds to the scheduled travel area that is received from among the actual consumption maps stored in the actual consumption map storage unit 534 or creating an actual resource consumption map that corresponds to the scheduled travel area, and step S2220 that is executed after step S2210, and involves repeating step S2222 described below until the processing on all target resources ends for each of the observation domains of the target resources, based on the information relating to the resource management targets. Step S2220 includes step S2222 that involves estimating the resource consumption of real-time apps in the scheduled travel area for each of the observation domains of the target resources, based on the actual resource consumption map.

This program, furthermore, includes step S2230 that is executed after step S2220, and involves extracting, as a recommended execution period, a period in which non-real-time apps that are executed in the in-vehicle device 200B are executable, based on the resource consumption estimation result, and step S2240 that is executed after step S2230, and involves notifying the recommended execution period that is extracted to the in-vehicle device 200B that transmitted the information relating to the scheduled travel area and returning control to step S2200.

### In-Vehicle Device 200B

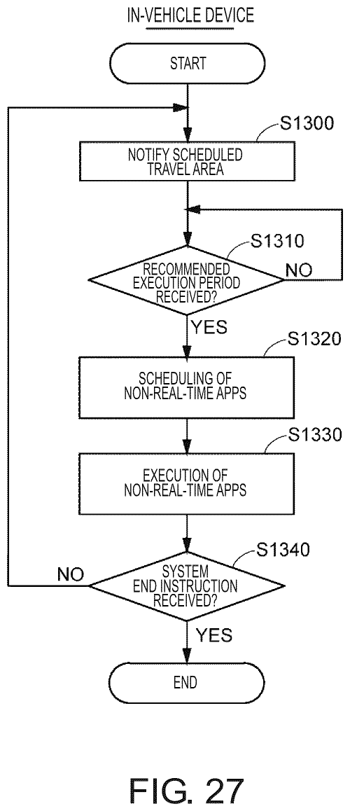

In the in-vehicle device 200B according to the present embodiment, a program shown in FIG. 27 is executed, instead of the program shown in FIG. 12.

Referring to FIG. 27, this program includes step S1300 that involves notifying information relating to a scheduled travel area and resource management targets of the vehicle to the server device 500A (see FIG. 24), step S1310 that is executed after step S1300, and involves waiting to receive a recommended execution period that is transmitted from the server device 500A, step S1320 that is executed if it is determined in step S1310 that a recommended execution period has been received, and involves scheduling the execution period of non-real-time apps, based on the recommended execution period that is received, step S1330 that is executed after step S1320, and involves executing non-real-time apps in the execution period set in the scheduling processing of step S1320, and step S1340 that is executed after step S1330, and involves determining whether a system end instruction has been given and branching the flow of control according to the determination result. If it is determined in step S1340 that the system end instruction has not been given (“NO”), control returns to step S1300. If it is determined in step S1340 that the system end instruction has been given (“YES”), this program ends.

The timing for notifying information relating to the scheduled travel area and resource management targets to the server device 500A in step S1300 is not particularly limited. As an example, the timing for notifying this information to the server device 500A can be any desired timing prior to the vehicle entering the scheduled travel area.

Similarly to the first embodiment, the server device 500A collects actual travel information from a plurality of preceding vehicles and creates an actual resource consumption map. The server device 500A extracts a recommended execution period in which execution of non-real-time apps is recommended, based on the created actual resource consumption map, and notifies the recommended execution period that is extracted to the in-vehicle device 200B. The in-vehicle device 200B distributes the execution periods of apps by allocating the execution period of non-real-time apps to the recommended execution period. The in-vehicle device 200B is thereby able to easily suppress a decrease in responsiveness during high load periods caused by out-of-vehicle wireless communication. In this way, the server device 500A, by notifying the recommended execution period of non-real-time apps to the in-vehicle device 200B, is able to support the in-vehicle device 200B so as to suppress a decrease in responsiveness during high load periods caused by out-of-vehicle wireless communication.

### Variations

In the above embodiments, examples are shown in which a GW device is provided with the function of a resource management unit, but the present disclosure is not limited to such embodiments. A device other than a GW device may be provided with the function of a resource management unit.

In the above embodiments, examples are shown in which the in-vehicle device includes a GW device and an out-of-vehicle wireless device, but the present disclosure is not limited to such embodiments. The in-vehicle device may be a device other than a GW device or an out-of-vehicle wireless device, such as an ECU, for example. That is, an ECU may be provided with the function of a resource management unit. Also, a dedicated ECU having the function of a resource management unit may be installed in the vehicle as an in-vehicle device. Furthermore, a resource management unit may be installed in a plurality of in-vehicle devices.

In the above embodiments, examples are shown in which the execution period of non-real-time apps is scheduled, but the present disclosure is not limited to such embodiments. In the case where the execution period of non-real-time apps has already been set, the execution period of non-real-time apps can also be reset (rescheduled), based on the resource consumption estimation result.

In the above embodiments, examples are shown in which the server device creates an actual resource consumption map of a scheduled travel area of the vehicle or a specific area, but the present disclosure is not limited to such embodiments. For example, the server device may be configured to create an actual resource consumption map of an area managed by a real device, extract an area that is required from a wide-ranging actual resource consumption map that is created, and deliver the extracted area to the vehicle.

Note that the various processing (various functions) of the above-described embodiments may be realized by circuitry including one or more processors. In addition to the one or more processors, the circuitry may be constituted by an integrated circuit or the like in which one or more memories, various analog circuits, and various digital circuits are combined. The one or more memories store programs (instructions) that cause the one or more processors to execute the various processing. The one or more processors may execute the various processing in accordance with the programs read out from the one or more memories or may execute the various processing in accordance with a logic circuit designed in advance to execute the various processing. The processors may be any of a variety of processors compatible with control of a computer, such as a CPU, GPU, DSP (Digital Signal Processor), FPGA (Field Programmable Gate Array), ASIC (Application Specific Integrated Circuit), and the like. Note that the plurality of processors that are physically separated may cooperate with each other to execute the various processing. For example, the processors installed in each of a plurality of computers that are physically separated may cooperate with each other via a network such as a LAN (Local Area Network), WAN (Wide Area Network) or the Internet to execute the various processing.

Embodiments obtained by combining the technologies disclosed above as appropriate are also included in the technical scope of the present disclosure.

The embodiments disclosed herein are merely exemplary, and the present disclosure is not limited to only the above described embodiments. The scope of the present disclosure is indicated by the claims, with reference to the detailed description of the disclosure, and embraces all changes that come within the meaning and range of equivalency of scope of the wording used therein.

1. An in-vehicle device to be installed in a vehicle, the in-vehicle device comprising:
a communication outlet that is configured to communicate with an external device; and
a processor that is configured to:
acquire, via the communication outlet, actual information of resource consumption by an other vehicle other than the vehicle relating to when the other vehicle travelled through a scheduled travel area of the vehicle;
estimate resource consumption that varies temporally with travel of the vehicle, when the vehicle travels through the scheduled travel area, based on the actual information acquired; and
control resource consumption, by allocating an execution period of predetermined application software to a predetermined period, according to the resource consumption estimated.

2. The in-vehicle device according to claim 1, wherein the processor is configured to:
estimate, for each travel section of the scheduled travel area, the resource consumption that varies according to the travel section and includes resource consumption due to execution of application software that requires real-time execution of processing, and
control resource consumption, by allocating an execution period of application software that does not require real-time execution of processing to the predetermined period, according to the resource consumption estimated.

3. The in-vehicle device according to claim 1, wherein:
the external device includes a server device configured to collect the actual information of resource consumption from a plurality of other vehicles, and create an actual resource consumption map in which actual resource consumption is set in each travel section of the scheduled travel area, based on the actual information collected, and
the processor is configured to:
acquire the actual resource consumption map as the actual information from the server device, via the communication outlet, and
estimate the resource consumption for each travel section of the scheduled travel area, based on the actual resource consumption map.

4. The in-vehicle device according to claim 1, wherein:
the external device includes an in-vehicle device installed in the other vehicle other than the vehicle, and
the processor is configured to:
acquire, via the communication outlet, the actual information of resource consumption in the scheduled travel area from the in-vehicle device of the other vehicle that has travelled through the scheduled travel area of the vehicle, and
estimate the resource consumption for each travel section of the scheduled travel area, based on the actual information of resource consumption acquired from the in-vehicle device of the other vehicle.

5. The in-vehicle device according to claim 1,
wherein the processor is configured to allocate an execution period of application software that does not require real-time execution of processing to a scheduled travel period of a travel section in which a ratio of resource consumption estimated to a resource usage limit is less than or equal to a predetermined value.

6. The in-vehicle device according to claim 5,
wherein the predetermined value is set based on resource consumption of the application software that does not require real-time performance.

7. The in-vehicle device according to claim 1,
wherein the actual information includes quantization information that is set for each travel section of the scheduled travel area and is obtained by actual values of resource consumption of the other vehicle that has travelled through the scheduled travel area being quantized into a plurality of levels.

8. The in-vehicle device according to claim 1,
wherein the processor is configured to acquire the actual information prior to the vehicle entering the scheduled travel area.

9. The in-vehicle device according to claim 1,
wherein the processor is configured to request the external device to transmit the actual information, prior to the vehicle entering the scheduled travel area.

10. The in-vehicle device according to claim 1, wherein:
time information indicating a date and time of generation of the actual information is added to the actual information, and
the processor is configured to compare the date and time indicated by the time information with a current date and time and estimates the resource consumption that varies temporally with travel of the vehicle, according to a comparison result.

11. A server device capable of communicating with an in-vehicle device installed in a vehicle, the server device comprising:
a processor that is configured to:
collect actual information of resource consumption from a plurality of vehicles;
receive information relating to a scheduled travel area from the in-vehicle device, and create an actual resource consumption map in which actual resource consumption is set in each travel section of the scheduled travel area, based on the actual information collected;
extract a recommended execution period in which execution of application software that does not require real-time execution of processing is recommended in a travel period through the scheduled travel area, based on the actual resource consumption map; and
notify the recommended execution period extracted to the in-vehicle device that transmitted the information relating to the scheduled travel area.

12. A resource control method in an in-vehicle device installed in a vehicle, the resource control method comprising:
acquiring, via a communication outlet that is configured to communicate with an external device, actual information of resource consumption by an other vehicle other than the vehicle relating to when the other vehicle travelled through a scheduled travel area of the vehicle;
estimating resource consumption that varies temporally with travel of the vehicle, when the vehicle travels through the scheduled travel area, based on the actual information acquired; and
controlling resource consumption, by allocating an execution period of predetermined application software to a predetermined period, according to the resource consumption estimated.

13. A resource control support method to be executed in a server device capable of communicating with an in-vehicle device installed in a vehicle, and for supporting control of resource consumption in the vehicle, the resource control support method comprising:
collecting actual information of resource consumption from a plurality of vehicles,
receiving information relating to a scheduled travel area from the in-vehicle device, and creating an actual resource consumption map in which actual resource consumption is set in each travel section of the scheduled travel area, based on the actual information collected;
extracting a recommended execution period in which execution of application software that does not require real-time execution of processing is recommended in a travel period through the scheduled travel area, based on the actual resource consumption map; and
notifying the recommended execution period extracted to the in-vehicle device that transmitted the information relating to the scheduled travel area.

14. A storage medium that stores a computer program that causes a processor installed in a vehicle to:
communicate with an external device;
acquire, via a communication outlet, actual information of resource consumption by an other vehicle other than the vehicle relating to when the other vehicle travelled through a scheduled travel area of the vehicle;
estimate resource consumption that varies temporally with travel of the vehicle, when the vehicle travels through the scheduled travel area, based on the actual information acquired; and
control resource consumption, by allocating an execution period of predetermined application software to a predetermined period, according to the resource consumption estimated.

15. A storage medium that stores a computer program that causes a processor to:
collect actual information of resource consumption from a plurality of vehicles;
receive information relating to a scheduled travel area from an in-vehicle device, and create an actual resource consumption map in which actual resource consumption is set in each travel section of the scheduled travel area, based on the actual information collected;
extract a recommended execution period in which execution of application software that does not require real-time execution of processing is recommended in a travel period through the scheduled travel area, based on the actual resource consumption map; and
notify the recommended execution period extracted to the in-vehicle device that transmitted the information relating to the scheduled travel area.

16. The in-vehicle device according to claim 2, wherein:
the external device includes a server device configured to collect the actual information of resource consumption from a plurality of other vehicles, and create an actual resource consumption map in which actual resource consumption is set in each travel section of the scheduled travel area, based on the actual information collected, and
the processor is configured to:
acquire the actual resource consumption map as the actual information from the server device, via the communication outlet, and
estimate the resource consumption for each travel section of the scheduled travel area, based on the actual resource consumption map.

17. The in-vehicle device according to claim 2, wherein:
the external device includes an in-vehicle device installed in the other vehicle other than the vehicle, and
the processor is configured to:
acquire, via the communication outlet, the actual information of resource consumption in the scheduled travel area from the in-vehicle device of the other vehicle that has travelled through the scheduled travel area of the vehicle, and
estimate the resource consumption for each travel section of the scheduled travel area, based on the actual information of resource consumption acquired from the in-vehicle device of the other vehicle.

18. The in-vehicle device according to claim 2,
wherein the processor is configured to allocate an execution period of application software that does not require real-time execution of processing to a scheduled travel period of a travel section in which a ratio of resource consumption estimated to a resource usage limit is less than or equal to a predetermined value.

19. The in-vehicle device according to claim 2,
wherein the actual information includes quantization information that is set for each travel section of the scheduled travel area and is obtained by actual values of resource consumption of the other vehicle that has travelled through the scheduled travel area being quantized into a plurality of levels.

20. The in-vehicle device according to claim 2,
wherein the processor is configured to acquire the actual information prior to the vehicle entering the scheduled travel area.
